(19) United States
(12) Patent Application Publication
(10) Pub. No.: US 2026/0234323 A1
(43) Pub. Date: Aug. 13, 2026

(54) NOVEL POLYESTER COMPOSITIONS CONTAINING ETHYLENE GLYCOL RESIDUES AND IMPROVED PROCESSES FOR MAKING POLYESTERS FROM OLIGOMERIC ETHYLENE TEREPHTHALATE

(71) Applicant: Eastman Chemical Company, Kingsport, TN (US)

(72) Inventor: Emmett Dudley Crawford, Kingsport, TN (US)

(73) Assignee: Eastman Chemical Company, Kingsport, TN (US)

(21) Appl. No.: 19/154,613

(22) PCT Filed: Feb. 5, 2024
(86) PCT No.: PCT/US2024/014393

§ 371 Date: Aug. 7, 2025

Related U.S. Application Data
(60) Provisional application No. 63/484,338, filed on Feb. 10, 2023.

(51) Int. Cl. C08G 63/19; C08G 63/181; C08G 63/199; C08G 63/78; C08G 63/86

(52) U.S. Cl. CPC C08G 63/19; C08G 63/181; C08G 63/199; C08G 63/863; C08G 63/785

(57) ABSTRACT

This invention relates to a polyester composition comprising: (1) at least one polyester which comprises: (a) a dicarboxylic acid component comprising: (i) about 70 to about 100 mole % residues of terephthalic acid or esters thereof; (ii) about 0 to about 30 mole % of aromatic or aliphatic dicarboxylic acid residues, or combinations thereof, having up to 20 carbon atoms; (b) a glycol component comprising: (i) about 50 to about 100 mole % of ethylene glycol residues; (ii) about 0 to about 50 mole % residues of modifying glycols comprising linear or alicyclic residues containing 2 to 20 carbon atoms; wherein the total mole % of the dicarboxylic acid component is 100 mole %, wherein the total mole % of the diol component is 100 mole %; and (2) residues of a single metal catalyst system consisting essentially or consisting of germanium atoms in the amount of less than 75 ppm, relative to the mass of final polyester being prepared; and wherein the inherent viscosity of the final polyester is 0.45 to 1.2 dL/g as determined in 60/40 (wt/wt) phenol/tetrachloroethane at a concentration of 0.5 g/100 ml at 25° C.

### FIELD OF THE INVENTION

The present invention relates to polyester compositions made by the polycondensation of oligomeric ethylene terephthalate (BHET).

The polyester compositions can be catalyzed by a catalyst system that contains germanium, resulting in good molecular weight, good color, good environmental benefits, circular economy benefits, and other benefits. The final polyester comprises little to no catalyst residues.

### BACKGROUND OF THE INVENTION

Germanium catalysts have been used in making polyesters. U.S. Pat. Nos. 2,578,660, 3,074,913, and 3,377,320 disclose polyesters prepared using an ester-interchange catalyst and a germanium compound as a polycondensation catalyst.

U.S. Pat. No. 5,378,796 discloses use of a germanium catalyst as a polycondensation catalyst in certain polyesters containing 1,4-cyclohexanedimethanol and ethylene glycol.

U.S. Pat. No. 7,153,811 teaches away from using germanium alone as a catalyst because of the high cost of germanium. This patent teaches certain multi-component germanium-based catalyst systems.

EP1153193 teaches use of bis(2-hydroxyethyl) terephthalates to make PET. It also teaches that “germanium catalyst is problematically expensive and tends to be distilled from a reaction system during a polymerization, resulting in a change in the catalyst concentration in the reaction system, which leads to a difficulty in controlling the polymerization”. EP1153193 also mentions that “an additional problem which is somewhat unique to germanium catalysis is the volatility of germanium compounds. Thus, at the high temperature and high vacuum of the prior art finishing processes, significant loss of germanium occurs. Since germanium is far more expensive than antimony, this loss is economically very disadvantageous. This expense, coupled with the need to solid state polymerize, has limited the use of germanium catalysts.”

There have been other methods to make catalyst free PET type polymers, such as catalyst deactivation and filtering. However, filtering a polymer melt is very impractical due to its viscous nature. Another route reported in the literature is to use heterogenous catalysis. Achieving polymer flow across such a catalyst is difficult and impractical. In many cases, the heterogenous catalysts can breakdown in such situations and form chemical entities that end up being in the final polymer and have essentially acted as a homogenous catalyst.

In US 2008/0051530 A1, the following is described: “polyesters prepared using germanium catalyst in the finishing stage at temperatures less than 285° C. and exhibiting low loss of Ge catalyst and excellent low acetaldehyde generating characteristics. Once an It.V. of 0.72 dL/g has been reached at a temperature of 275° C. or less, a catalyst-removal post-finishing process can be applied by subjecting the polymer melt to a temperature higher than 275° C., such as 280° C.-305° C., generally for a relatively brief period, to lower the germanium catalyst content in the polyester to 40% or less of the initially charged amount. Removal of germanium catalyst by post finishing (after the finisher reactor) in this manner may be accomplished by rerouting volatiles from the reactor so that germanium may be recovered and preferably recycled.” In US 2008/0051530 A1, it is also stated that “it is desirable to lose as little germanium catalyst as possible.”

There is a commercial need for an ethylene glycol containing polyester having low to no levels of catalyst(s), having good color, good molecular weight, good inherent viscosity, good thermal stability, and other combinations of properties making it useful for injection molding, blow molding, extrusion, and film and sheet applications. It would be useful if the process of making these polyesters did not require heterogeneous catalysis, filtering, post finishing reactors or vessels, catalyst deactivation, solid stating, addition of phosphorus stabilizers, or crystallization promoters.

There is also commercial need for a simple process for preparing polyesters in a finisher reactor using germanium catalyst providing high loss of germanium catalyst (low catalyst levels remaining in the polymer) and high germanium catalyst recovery while still retaining a high inherent viscosity polymer, without the need for a post-finishing step to remove catalyst from the higher inherent viscosity polymer obtained in a finishing reactor.

### SUMMARY OF THE INVENTION

This invention relates to novel polyesters and/or polyester compositions comprising residues of ethylene glycol which comprise minimal catalyst residues, which can have a combination of one or more, two or more, or three or more of the following properties: good color, good molecular weight, good inherent viscosity, good thermal stability, and other combinations of properties making it ideal for injection molding. The polyesters of the invention are ideal as high catalyst residues often lead to degradation or other issues during chemical and mechanical recycling of polyesters.

It is unpredictable that there is a simple process to make PET and other EG-containing copolyesters to high molecular weight (as represented by IV) having the above-described properties and having little to no residual catalyst in the final polyester. There are other advantages as well including but not limited to environmental benefits, circular economy benefits, and performance benefits. There is an environmental desire to reduce the number of additives and catalyst metals in products. Given that germanium catalyzed PET has excellent color, PET made with excellent color requires the use of less toner dyes in the final product to achieve the desired nearly perfectly neutral color. In addition to environmental concerns, it is desirable to have nearly clean PET in a world where material can be recycled chemically or mechanically. Removal of catalyst and other additive chemicals in plastic is quite complex in chemical recycling technologies and, therefore, such a product without catalyst residues and additives would be advantageous. It is also anticipated that having lower catalyst residues in the final polyester will improve the thermal stability of PET and copolyesters based on EG.

While the process can result in a minimal to no catalyst level in the final product, it can also include steps for removal of catalyst and catalyst recovery so that the catalyst can be re-used in additional processes. The process can minimalize the loss of catalyst. It is also believed that the germanium catalyst removed from the reaction process in the finisher or finishing reactor can be recycled, treated, and can be reused, and thereby can minimize the loss of catalyst. The process(es) of the invention for making these polyesters can achieve desirable and useful inherent viscosities as well as reasonable production times.

In one aspect, the polyesters can be recycled without having to remove significant catalyst content.

In one aspect, the processes of the invention do not require at least one or more of the following: heterogeneous catalysis, filtering, post-finisher operations, catalyst deactivation of final product, solid stating, addition of phosphorus stabilizers, or crystallization promoters.

In one aspect, the processes of the invention do not require at least one or more of the following: high processing temperatures (e.g., 290° C. or higher), a post-finisher reactor, a post-finishing reaction, a post-finisher step to achieve the high inherent viscosities of the polyesters of the invention.

Generally, this invention also relates to a process for preparing using germanium catalyst (Ge) in the finishing stage at temperatures of 240° C. to 300° C. and exhibiting high loss of Ge catalyst (low catalyst levels remaining in the polymer) while still retaining a high inherent viscosity polymer without the need for a post-finishing step. The advantages of this process can include but are not limited to eliminating additional process steps to remove germanium catalyst while having minimal catalyst levels remaining in the polymer, the ability to recover a high amount of the germanium catalyst so that it can be recycled. This can further result in lower costs because of the high price of germanium catalyst.

In aspect 1, this invention relates to a polyester composition comprising:
(1) at least one polyester which comprises:
   (a) a dicarboxylic acid component comprising:
      (i) about 70 to about 100 mole % residues of terephthalic acid or esters thereof;
      (ii) about 0 to about 30 mole % of aromatic or aliphatic dicarboxylic acid residues, or combinations thereof, having up to 20 carbon atoms;
   (b) a glycol component comprising:
      (i) about 50 to about 100 mole % of ethylene glycol residues;
      (ii) about 0 to about 50 mole % residues of modifying glycols comprising linear or alicyclic residues containing 2 to 20 carbon atoms;
wherein the total mole % of the dicarboxylic acid component is 100 mole %, wherein the total mole % of the diol component is 100 mole %; and
(2) residues of a metal catalyst system consisting essentially or consisting of germanium atoms in the amount of less than 75 ppm, or less than 70 ppm, or less than 65 ppm, or less than 60 ppm, or less than 55 ppm, or less than 50 ppm, or less than 45 ppm, or less than 40 ppm, or less than 35 ppm, or less than 30 ppm, or less than 25 ppm, or less than 20 ppm, or less than 15 ppm, or 10 ppm or less, or 5 ppm or less, of germanium atoms present in the final polyester, relative to the mass of final polyester being prepared; and
   wherein the inherent viscosity of the final polyester is 0.35 to 1.2 dL/g, or 0.45 to 1.2 dL/g, or 0.50 to 1.2 dL/g, or 0.55 to 1.2 dL/g, or 0.60 to 1.2 dL/g, or 0.65 to 1.2 dL/g, or 0.65 to 0.90 dL/g, as determined in 60/40 (wt/wt) phenol/tetrachloroethane at a concentration of 0.5 g/100 ml at 25° C.

In aspect 2, this invention relates to a polyester composition comprising:
(1) at least one polyester which comprises:
   (a) a dicarboxylic acid component comprising:
      (i) about 70 to about 100 mole % residues of terephthalic acid or esters thereof;
      (ii) about 0 to about 30 mole % of aromatic or aliphatic dicarboxylic acid residues, or combinations thereof, having up to 20 carbon atoms;
   (b) a glycol component comprising:
      (i) about 50 to about 100 mole % of ethylene glycol residues;
      (ii) about 0 to about 50 mole % residues of modifying glycols comprising linear or alicyclic residues containing 2 to 20 carbon atoms;
wherein the total mole % of the dicarboxylic acid component is 100 mole %, wherein the total mole % of the diol component is 100 mole %; and
(2) residues of a metal catalyst system consisting essentially of or consisting of germanium atoms present in the final polyester in the amount of less than 30 ppm, or less than 25 ppm, or less than 20 ppm, or less than 15 ppm, or 10 ppm or less, or 5 ppm or less, or less than 5 ppm, relative to the mass of final polyester being prepared; and
wherein the inherent viscosity of the final polyester is is 0.35 to 1.2 dL/g, or 0.45 to 1.2 dL/g, or 0.50 to 1.2 dL/g, or 0.55 to 1.2 dL/g, or 0.60 to 1.2 dL/g, or 0.65 to 1.2 dL/g, or 0.65 to 0.90 dL/g, as determined in 60/40 (wt/wt) phenol/tetrachloroethane at a concentration of 0.5 g/100 ml at 25° C.

In aspect 3, this invention relates to a polyester composition comprising:
(1) at least one polyester which comprises:
   (a) a dicarboxylic acid component comprising:
      (i) about 70 to about 100 mole % residues of terephthalic acid or esters thereof;
      (ii) about 0 to about 30 mole % of aromatic or aliphatic dicarboxylic acid residues, or combinations thereof, having up to 20 carbon atoms;
   (b) a glycol component comprising:
      (i) about 50 to about 100 mole % of ethylene glycol residues;
      (ii) about 0 to about 50 mole % residues of modifying glycols comprising linear or alicyclic residues containing 2 to 20 carbon atoms;
wherein the total mole % of the dicarboxylic acid component is 100 mole %, wherein the total mole % of the diol component is 100 mole %; and
(2) residues of a metal catalyst system consisting essentially of or consisting of germanium atoms in the amount of 5 ppm or less, or less than 5 ppm, relative to the mass of final polyester being prepared; and
   wherein the inherent viscosity of the final polyester is 0.35 to 1.2 dL/g, or 0.45 to 1.2 dL/g, or 0.50 to 1.2 dL/g, or 0.55 to 1.2 dL/g, or 0.60 to 1.2 dL/g, or 0.65 to 1.2 dL/g, or 0.65 to 0.90 dL/g, as determined in 60/40 (wt/wt) phenol/tetrachloroethane at a concentration of 0.5 g/100 ml at 25° C.

In aspect 4, this invention relates to the polyester composition of any of aspects 1-3, wherein said modifying glycols comprise at least one of diethylene glycol, 1,2-propanediol, 1,3-propanediol, 2-methyl-1,3-propanediol, 1,4-cyclohexanedimethanol, 2,2,4,4-tetramethyl-1,3-cyclobutanediol, 1,4-butanediol, 1,5-pentanediol, 1,6-hexanediol, p-xylene glycol, neopentyl glycol, isosorbide, polytetramethylene glycol, or combinations thereof.

In aspect 5, this invention relates to the polyester composition of any of aspects 1-4, wherein said modifying glycol comprises residues of 2,2,4,4-tetramethyl-1,3-cyclobutanediol.

In aspect 6, this invention relates to the polyester composition of any of aspects 1-5, wherein said modifying glycol comprises residues of 1,4-cyclohexanedimethanol.

In aspect 7, this invention relates to the polyester composition of any of aspects 1-6, wherein said modifying glycol is in the amount of from about 10 to about 45 mole %, or from about 15 to about 45 mole %, or from about 10 to about 40 mole %, or from about 20 to about 40 mole %, or from about 10 to about 30 mole %, or from about 20 to about 35 mole %, or from about 20 to about 30 mole %, or from about 25 to about 40 mole %, or from about 30 to about 40 mole %.

In aspect 8, this invention relates to the polyester composition of any of aspects 1-7, wherein said polyester comprises residues of ethylene glycol in the amount of from about 55 to about 90 mole %, or from about 55 to about 85 mole %, or from about 60 to about 90 mole %, or from about 60 to about 80 mole %, or from about 65 to about 80 mole %, or from about 70 to about 90 mole %, or from about 70 to about 80 mole % or from about 60 to about 75 mole %, or from about 60 to about 70 mole %.

In aspect 9, this invention relates to the polyester composition of any of aspects 1-8, wherein said polyester comprises residues of a diacid component comprising aromatic or aliphatic dicarboxylic acid ester residues, or combinations thereof.

In aspect 10, this invention relates to the polyester composition of any of aspects 1-9, wherein said polyester comprises from about 80 to about 100 mole %, or to about 90 to about 100 mole %, or about 95 to about 100 mole %, or about 99 to about 100 mole %, of residues of terephthalic acid or esters thereof.

In aspect 11, this invention relates to the polyester composition of any of aspects 1-10, wherein the inherent viscosity of the polyester is from 0.45 to 1.2 dL/g, or from 0.45 to 1.0 dL/g, or from 0.45 to 0.90 dL/g, or from 0.45 to 0.85 dL/g, or from 0.45 to 0.80 dL/g, or from 0.45 to 0.75 dL/g, or from 0.45 to 0.70 dL/g, or from 0.50 to 1.2 dL/g, or from 0.50 to 1.0 dL/g, or from 0.50 to 0.90 dL/g, or from 0.50 to 0.85 dL/g, or from 0.50 to 0.80 dL/g, or from 0.50 to 0.75 dL/g, or from 0.50 to 0.70 dL/g, or from 0.55 to 1.2 dL/g, or from 0.55 to 1.0 dL/g, or from 0.55 to 0.90 dL/g, or from 0.55 to 0.85 dL/g, or from 0.55 to 0.80 dL/g, or from 0.55 to 0.75 dL/g, or from 0.55 to 0.70 dL/g, or 0.60 to 1.2 dL/g, or from 0.60 to 1.0 dL/g, or from 0.60 to 0.90 dL/g, or from 0.60 to 0.85 dL/g, or from 0.60 to 0.80 dL/g, or from 0.60 to 0.75 dL/g, or from 0.60 to 0.70 dL/g, or from 0.65 to 1.2 dL/g, or from 0.65 to 1.0 dL/g, or from 0.65 to 0.90 dL/g, or from 0.65 to 0.85 dL/g, or from 0.65 to 0.80 dL/g, or from 0.65 to 0.75 dL/g, or from 0.68 to 1.2 dL/g, or from 0.60 to 1.0 dL/g, or from 0.68 to 0.90 dL/g, or from 0.68 to 0.85 dL/g, or from 0.68 to 0.80 dL/g, as determined in 60/40 (wt/wt) phenol/tetrachloroethane at a concentration of 0.5 g/100 ml at 25° C.

In aspect 12, this invention relates to the polyester composition of any of aspects 1-11, wherein the inherent viscosity of the polyester is from 0.45 to 0.85 dL/g, or from 0.45 to 0.80 dL/g, or from 0.55 to 0.85 dL/g, or from 0.65 to 0.85 dL/g, or from 0.65 to 0.80 dL/g, or from 0.65 to 0.75 dL/g, or from 0.60 to 0.85 dL/g, or from 0.60 to 0.80 dL/g, or from 0.60 to 0.75 dL/g, or from 0.65 to 0.85 dL/g, or from 0.68 to 0.85 dL/g, as determined in 60/40 (wt/wt) phenol/tetrachloroethane at a concentration of 0.5 g/100 ml at 25° C.

In aspect 13, this invention relates to the polyester composition of any of aspects 1-12, wherein less than 70 ppm, or less than 65 ppm, or less than 60 ppm, or less than 55 ppm, or less than 50 ppm, or less than 45 ppm, or less than 40 ppm, or less than 35 ppm, or less than 30 ppm, or less than 25 ppm, or less than 20 ppm, or less than 15 ppm, or 25 ppm or less, or 20 ppm or less, or 15 ppm or less, or 10 ppm or less, or 5 ppm or less, or less than 5 ppm, of germanium atoms are present in the final polyester composition.

In aspect 14, this invention relates to the polyester composition of any of aspects 1-13, wherein the inherent viscosity of the polyester is from 0.50 to 1.2 dL/g, or from 0.50 to 1.0 dL/g, or from 0.50 to 0.90 dL/g, or from 0.50 to 0.85 dL/g, or from 0.50 to 0.80 dL/g, or from 0.50 to 0.80 dL/g, and the amount of germanium atoms present in the final polyester composition is 18 ppm or less, or 15 ppm or less, or 10 ppm or less, or 5 ppm or less, or less than 5 ppm.

In aspect 15, this invention relates to the polyester composition of any of aspects 1-14, wherein the inherent viscosity of the polyester is from 0.50 to 1.2 dL/g, or from 0.50 to 1.0 dL/g, or from 0.60 to 1.2 dL/g, or from 0.60 to 1.0 dL/g, or from 0.60 to 0.90 dL/g, or from 0.60 to 0.85 dL/g or from 0.65 to 1.2 dL/g, or from 0.65 to 1.0 dL/g, or from 0.65 to 0.90 dL/g, or from 0.65 to 0.85 dL/g.

In aspect 16, this invention relates to the polyester composition of any of aspects 1-15, wherein the amount of germanium atoms present in the final polyester composition is 20 ppm or less, or 18 ppm or less, or 15 ppm or less, or 10 ppm or less, or 5 ppm or less.

In aspect 17, this invention relates to the polyester composition of any of aspects 1-16, wherein the final amount of germanium atoms in the final polyester composition is 5 ppm or less, or less than 5 ppm, or less than 4 ppm, or less than 3 ppm, or less than 2 ppm, or less than 1 ppm, or 0 ppm.

In aspect 18, this invention relates to the polyester composition of any of aspects 1-17, having a b* value of from −10 to less than 20, −10 to less than 10, or from 1 to less than 20, or from 5 to less than 20, or from 8 to less than 20, or from −3 to 10, or from −5 to 5, or from −5 to 4, or from −5 to 3, or from 1 to 15, or from 1 to 14, or from 1 to 13, or from 1 to 12, or from 1 to 11, or from 1 to 10, or from 1 to 9, or from 1 to 8, from 1 to 7, or from 1 to 6, or from 1 to 5, or less than 20, or less than 15, or less than 10, or less than 8, or less than 7, or less than 6, or less than 5, or less than 4, or less than 3, as determined by the L*a*b* color system of the CIE (International Commission on Illumination).

In aspect 19, this invention relates to the polyester composition of any of aspects 1-18, having a b* value of from less than 10, or less than 8, or less than 7, or less than 6, or less than 5, or less than 4, or less than 3.

In aspect 20, this invention relates to the polyester composition of any of aspects 1-19, having a L* value of from 50 to 99, or from 50 to 90, or from 60 to 99, or from 60 to 90, or from 60 to 85, or from 60 to 80, or from 65 to 99, or from 65 to 90, or from 65 to 85, or from 65 to 80, or from 65 to 75, or from 70 to 90, or from 70 to 99, or from 70 to 90, or from 70 to 85, or from 70 to 80, or from 75 to 95, or from 75 to 90, or from 75 to 85, or from 80 to 90, as determined by the L*a*b* color system of the CIE (International Commission on Illumination).

In aspect 21, this invention relates to the polyester composition of any of aspects 1-20, wherein said polyester comprises residues of at least one branching agent or comprises no branching agent or comprises 1 mole % or less branching agent.

In aspect 22, this invention relates to the polyester composition of any of aspects 1-21, wherein at least one germanium compound is selected from germanium alkoxides, germanium carboxylates, organogermanium compounds, or esters of germanic acid.

In aspect 23, this invention relates to the polyester composition of any of aspects 1-22, wherein at least one germanium compound is selected from germanium alkoxides and carboxylates.

In aspect 24, this invention relates to the polyester composition of any of aspects 1-23, wherein said germanium compound is selected from germanium ethoxide, germanium isopropoxide, and germanium acetate, or germanium dioxide.

In aspect 25, this invention relates to the polyester composition of any of aspects 1-24, comprising a blend with at least one polymer chosen from at least one of the following: polyesters other than those in aspects 1-24, poly(etherimides), polyphenylene oxides, poly(phenylene oxide)/polystyrene blends, polystyrene resins, polyphenylene sulfides, polyphenylene sulfide/sulfones, poly(ester-carbonates), polycarbonates, polysulfones; polysulfone ethers, and poly(ether-ketones).

In aspect 26, this invention relates to a process for making any of the polyesters of aspects 1-24.

In aspect 27, this invention relates to a process for making any of the polyesters of aspects 1-24, wherein the loss of catalyst or removal of catalyst is greater than 70%, or greater than 75%, or greater than 80%, or greater than 85%, or greater than 86%, or greater than 87%, or greater than 88%, or greater than 89%, or greater than 90%, or greater than 95%, or greater than 96%, or greater than 97%, or greater than 98%, or greater than 99%.

In aspect 28, this invention relates to any of the processes of aspects 26-27, wherein said loss of catalyst or removal of catalyst occurs by application of vacuum or by nitrogen purge. In one aspect, the loss of catalyst or removal of catalyst occurs in the finisher or finishing reactor and/or not in a post-finishing stage.

In aspect 29, this invention relates to any of the processes of aspects 26-28, wherein the amount of germanium catalyst introduced to the polycondensation zone can be in the amount of at least 20 ppm, or at least 50 ppm, or at least 100 ppm, or from 20 to 500 ppm, or from 20 to 450 ppm, or from 20 to 400 ppm, or from 20 to 350 ppm, or from 20 to 300 ppm, or from 20 to 250 ppm, or from 50 to 500 ppm, or from 50 to 450 ppm, or from 50 to 400 ppm, or from 50 to 350 ppm, or from 50 to 300 ppm, or from 50 to 250 ppm, or from 100 to 500 ppm, or from 100 to 450 ppm, or from 20 to 400 ppm, or from 100 to 350 ppm, or from 100 to 300 ppm, or from 100 to 250 ppm, or from 150 to 500 ppm, or from 150 to 450 ppm, or from 150 to 400 ppm, or from 150 to 350 ppm, or from 150 to 300 ppm, or from 150 to 250 ppm, or from 175 to 500 ppm, or from 175 to 450 ppm, or from 175 to 400 ppm, or from 175 to 350 ppm, or from 175 to 300 ppm, or from 175 to 250 ppm, or from 200 to 500 ppm, or from 200 to 450 ppm, or from 200 to 400 ppm, or from 200 to 350 ppm, or from 200 to 300 ppm, or from 200 to 250 ppm.

In aspect 30, this invention relates to any of the processes of aspects 26-29, wherein said reactor, or said reactors, or finishing reactors can be selected from thin film reactors or vertical finishing reactors. These reactors can include, but are not limited, to falling film evaporators, falling film reactors, zimmer (horizontal) finishers, and tray finishers, other horizontal type finishers, for example, horizontal cylindrical reactors (see U.S. Pat. No. 3,728,083A, incorporated herein by reference, which describes reactors where wagon wheels pull up and make a thin polymer film from which volatile compounds like EG and in this case Ge can be removed). Also, for example, see U.S. Pat. No. 4,196,168A, incorporated herein by reference.

In aspect 31, this invention relates to any of the processes of aspects 26-30, wherein at least one dihydroxy terephthalate-containing compound is fed to a finishing reactor operating in the range of 180° C. to 300° C. with vacuum levels between 0.1-5 torr and a total process time of from 15 minutes to 8 hours wherein germanium is a catalyst and wherein the final product has an inherent viscosity of at least 0.45 dL/g and contains less than 75 ppm germanium atoms.

In aspect 32, this invention relates to any of the processes of aspects 26-31, wherein at least one dihydroxy terephthalate-containing compound is fed to a finishing reactor operating in the range of 240° C. to 300° C. with vacuum levels between 0.1-5 torr and a total process time of from 15 minutes to 8 hours wherein germanium is a catalyst and wherein the final product has an inherent viscosity of at least 0.45 dL/g, or from 0.45 to 1.2 dL/g, or from 0.50 to 1.2 dL/g, or from 0.55 to 1.2 dL/g, or from 0.60 to 1.2 dL/g, or from 0.65 to 1.2 dL/g, or from 0.65 to 0.90 dL/g, and contains less than 75 ppm germanium atoms.

In aspect 33, this invention relates to a process for making any of the polyesters of the invention wherein at least one dihydroxy terephthalate-containing compound is fed to a finishing reactor operating in the range of 240° C. to 300° C. with vacuum levels between 0.1-1 torr and a total process time of from 15 minutes to 8 hours wherein germanium is a catalyst and wherein the final product has an inherent viscosity of at least 0.65 dL/g and comprises less than 75 ppm, or less than 50 ppm, or less 25 ppm, or less than 15 ppm, or less than 10 ppm, germanium atoms.

In aspect 34, this invention relates to the process for making the polyester compositions of any of aspects 26-33 wherein the dihydroxy terephthalate-containing compound comprises:

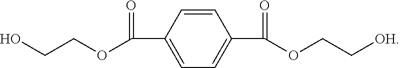 [SMILES: O=C(OCCO)c1ccc(C(=O)OCCO)cc1]

In aspect 35, this invention relates to any of the processes of aspects 26-34 wherein the dihydroxy terephthalate-containing compound, component (A), and optionally, a diol is reacted in the presence of polycondensation catalyst consisting essentially of or consisting of germanium atoms.

In aspect 36 this invention relates to any of the processes of aspects 26-35, wherein the dihydroxy terephthalate-containing compound is bis-2-hydroxyethyl terephthalate (BHET).

In aspect 37, the invention provides a process wherein the dihydroxy terephthalate-containing compound (e.g., BHET or oligomers thereof) can be added to a finishing reactor that has features providing a high surface area to volume ratio.

In aspect 38, this invention relates to any of the processes of aspects 26-37 wherein 1,4-cyclohexanedimethanol is a modifying glycol.

In aspect 39, this invention relates to any of the processes of aspects 26-38 wherein is 2,2,4,4-tetramethyl-1,3-cyclobutanediol is a modifying glycol.

In aspect 40, this invention relates of any of the processes of aspects 26-39, wherein the process is conducted at 180° C. to 300° C., or from 200° C. to 300° C.; or from 200° C. to 285° C.; or from 200° C. to 280° C.; or from 200° C. to 275° C.; or from 225° C. to 300° C.; or from 225° C. to 285° C.; or from 225° C. to 280° C.; or from 245° C. to 280° C.; or from 245° C. to 275° C.; or from 245° C. to 270° C.; or at or below 280° C., or at or below 275° C., or from 240° C. to 300° C., or from 240° C. to 290° C., or from 240° C. to less than 290° C., or from 240° C. to 285° C., or from 260° C. to 290° C., or from 260° C. to less than 290° C., or from 260° C. to 285° C., or from 270° C. to 290° C., or from 270° C. to less than 290° C., or from 270° C. to 285° C., or from 270° C. to 280° C., at a total process time of from 0.10 to 12 hours, or from 0.10 to 8 hours, or from 0.10 to 5 hours, or from 0.10 to 4 hours, or from 0.10 to 3 hours, to from 0.10 to 2 hours, or from 0.25 to 8 hours, or from 0.25 to 5 hours, or from 0.25 to 4 hours, or from 0.25 to 3 hours, to from 0.25 to 2 hours.

In aspect 41, this invention relates to any one of the processes of aspects 26-40 performed at a temperature of from 240° C. to 290° C., or from 240° C. to less than 290° C., or from 240° C. to 285° C., or from 260° C. to 290° C., or from 260° C. to less than 290° C., or from 260° C. to 285° C., or from 270° C. to 290° C., or from 270° C. to less than 290° C., or from 270° C. to 285° C., or from 270° C. to 280° C., for a total process time of from 0.25 to 8 hours.

In aspect 42, this invention relates to any of the processes of aspects 26-41 which can be carried out at a pressure of from 0.10 to 5 torr.

In aspect 43, this invention relates to any of the processes of aspects 26-42 which can be carried out at a pressure of from 0.10 to 3 torr.

In aspect 44, this invention relates to any of the processes of aspects 26-43 which are carried out at a pressure of from 0.10 to 1 torr.

In aspect 45, this invention relates to a product that can be made by any of the processes of aspects 26-44.

In aspect 46, this invention relates to an article of manufacture that can made with any of the polyester compositions of any of aspects 1-25 or by any of the processes of aspects 26-44.

In aspect 47, this invention relates to a shaped article made with any of the polyester compositions of any of aspects 1-25 or by any of the processes of aspects 26-44.

In aspect 48, the polyesters and/or the polyester compositions of the invention can be useful for thermoplastic polyester compositions, articles of manufacture, shaped articles, thermoplastic shaped articles, molded articles, extruded articles, injection molded articles, blow molded articles, film and/or sheet (for example, calendered, cast, or extruded), containers, and/or bottles (for example, beverage bottles, water bottles).

In aspect 49, the polyesters and/or the polyester compositions of the invention can be useful for films, sheets, bottle preforms, beverage bottle preforms, and blow molded bottles made therefrom.

In aspect 50, the polyester compositions of the invention are useful in shaped articles, including, but not limited to, extruded, and/or molded articles including, but not limited to, injection molded articles, extruded articles, cast extrusion articles, profile extrusion articles, melt spun articles, thermoformed articles, extrusion molded articles, injection blow molded articles, injection stretch blow molded articles, extrusion blow molded articles and extrusion stretch blow molded articles. These articles can include, but are not limited to, films, bottles, containers, drinkware, medical parts, sheet and/or fibers.

In aspect 51, the polyester compositions of the invention may be used in various types of film and/or sheet, including but not limited to extruded film(s) and/or sheet(s), compression molded film(s) and/or sheet(s), solution casted film(s) and/or sheet(s). Methods of making film and/or sheet include but are not limited to extrusion, compression molding, and solution casting.

In aspect 52, the invention is related to articles of manufacture, e.g., shaped articles, that comprise any of the polyesters or polyester compositions of the invention.

In aspect 53, any of the processes of making the polyesters useful in the invention and described herein or known by one of ordinary skill in the art may be used to make any of the polyesters and/or polyester compositions of the invention.

In aspect 54, any of the polyesters and/or polyester compositions described herein are also considered within the scope of this invention, regardless of which process is used to make them, and any products made therefrom.

In aspect 55, any of the processes of making the polyesters useful in the invention and described herein or known by one of ordinary skill in the art may be used to make any of the polyesters and/or polyester composition of the invention.

For any of the aspects of the invention, the metal catalyst system referred to herein can be a single metal catalyst system.

### DETAILED DESCRIPTION OF THE FIGURES

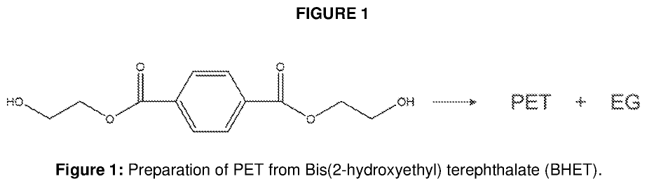

FIG. 1-FIG. 1 shows the synthesis of PET using BHET oligomer.

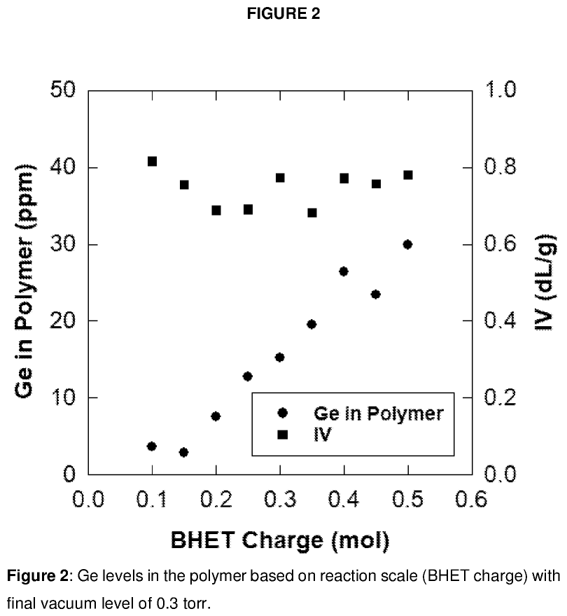

FIG. 2-FIG. 2 demonstrates germanium (Ge) levels in the polymer and polymer inherent viscosity (IV) based on reaction scale (BHET charge) with final vacuum level of 0.3 torr.

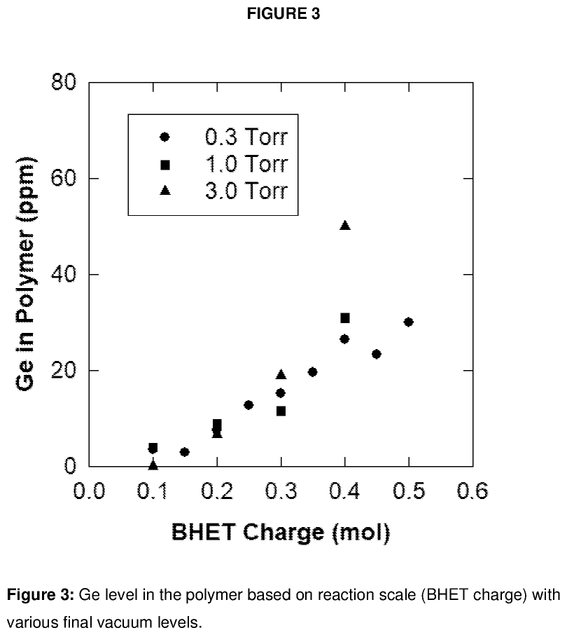

FIG. 3-FIG. 3 demonstrates germanium level in the polymer based on reaction scale (BHET charge) with various final vacuum levels.

### DETAILED DESCRIPTION OF THE INVENTION

The present invention may be understood more readily by reference to the following detailed description of certain embodiments of the invention and the working examples. In accordance with the purpose(s) of this invention, certain embodiments of the invention are described in the Summary of the Invention and are further described herein below. Also, other embodiments of the invention are described herein.

This invention relates to the preparation of polyethylene terephthalate or modified polyethylene terephthalates. More particularly, it relates to a process for the preparation of polyethylene terephthalate or modified polyethylene terephthalates by the polycondensation of oligomeric ethylene terephthalate (BHET).

The term “polyester”, as used herein, is intended to include “copolyesters” and is understood to mean a synthetic polymer prepared by the reaction of one or more difunctional carboxylic acids and/or multifunctional carboxylic acids with one or more difunctional hydroxyl compounds and/or multifunctional hydroxyl compounds, for example, branching agents. Typically, the difunctional carboxylic acid can be a dicarboxylic acid and the difunctional hydroxyl compound can be a dihydric alcohol such as, for example, glycols and diols. The term “glycol” as used herein includes, but is not limited to, diols, glycols, and/or multifunctional hydroxyl compounds, for example, branching agents. Alternatively, the difunctional carboxylic acid may be a hydroxy carboxylic acid such as, for example, p-hydroxybenzoic acid, and the difunctional hydroxyl compound may be an aromatic nucleus bearing 2 hydroxyl substituents such as, for example, hydroquinone. The term “residue”, as used herein, means any organic structure incorporated into a polymer through a polycondensation and/or an esterification reaction from the corresponding monomer. The term “repeating unit”, as used herein, means an organic structure having a dicarboxylic acid residue and a diol residue bonded through a carbonyloxy group. Thus, for example, the dicarboxylic acid residues may be derived from a dicarboxylic acid monomer or its associated acid halides, esters, salts, anhydrides, and/or mixtures thereof. Furthermore, as used herein, the term “diacid” includes multifunctional acids, for example, branching agents. As used herein, therefore, the term “dicarboxylic acid” is intended to include dicarboxylic acids and any derivative of a dicarboxylic acid, including its associated acid halides, esters, half-esters, salts, half-salts, anhydrides, mixed anhydrides, and/or mixtures thereof, useful in a reaction process with a diol to make polyester. As used herein, the term “terephthalic acid” is intended to include terephthalic acid itself and residues thereof as well as any derivative of terephthalic acid, including its associated acid halides, esters, half-esters, salts, half-salts, anhydrides, mixed anhydrides, and/or mixtures thereof or residues thereof useful in a reaction process with a diol to make polyester.

The polyesters used in the present invention typically can be prepared from dicarboxylic acids and diols which react in substantially equal proportions and are incorporated into the polyester polymer as their corresponding residues. The polyesters of the present invention, therefore, can contain substantially equal molar proportions of acid residues (100 mole %) and diol (and/or multifunctional hydroxyl compound) residues (100 mole %) such that the total moles of repeating units is equal to 100 mole %. The mole percentages provided in the present disclosure, therefore, may be based on the total moles of acid residues, the total moles of diol residues, or the total moles of repeating units. For example, a polyester containing 10 mole % isophthalic acid, based on the total acid residues, means the polyester contains 10 mole % isophthalic acid residues out of a total of 100 mole % acid residues. Thus, there are 10 moles of isophthalic acid residues among every 100 moles of acid residues. In another example, a polyester containing 80 mole % EG, based on the total diol residues, means the polyester contains 80 mole % EG residues out of a total of 100 mole % diol residues.

In one embodiment, this invention provides a process for preparing using germanium catalyst, optionally in the finishing stage, at temperatures of 240° C. to 300° C. and exhibiting high loss of Ge catalyst (low catalyst levels remaining in the polymer) while still retaining a high inherent viscosity polymer without the need for a post-finishing step. The advantages for this process can include but are not limited to eliminating additional process steps to remove germanium catalyst while having minimal catalyst levels remaining in the polymer, the ability to recover a high amount of the germanium catalyst so that it can be recycled. This further results in lower costs because of the high price of germanium catalyst.

In one embodiment, a polyester composition is provided comprising:
(1) at least one polyester which comprises:
   (a) a dicarboxylic acid component comprising:
      (i) about 70 to about 100 mole % residues of terephthalic acid or esters thereof;
      (ii) about 0 to about 30 mole % of aromatic or aliphatic dicarboxylic acid residues, or combinations thereof, having up to 20 carbon atoms;
   (b) a glycol component comprising:
      (i) about 50 to about 100 mole % of ethylene glycol residues;
      (ii) about 0 to about 50 mole % residues of modifying glycols comprising linear or alicyclic residues containing 2 to 20 carbon atoms;
   wherein the total mole % of the dicarboxylic acid component is 100 mole %,
wherein the total mole % of the diol component is 100 mole %; and
(2) residues of a metal catalyst system consisting essentially of or consisting of germanium atoms in the amount of less than 75 ppm, or less than 70 ppm, or less than 65 ppm, or less than 60 ppm, or less than 55 ppm, or less than 50 ppm, or less than 45 ppm, or less than 40 ppm, or less than 35 ppm, or less than 30 ppm, or less than 25 ppm, or less than 20 ppm, or less than 15 ppm, or 10 ppm or less, or 5 ppm or less, or less than 5 ppm, of germanium atoms present in the final polyester, relative to the mass of final polyester being prepared; and
   wherein the inherent viscosity of the final polyester is 0.35 to 1.2 dL/g, or 0.45 to 1.2 dL/g, or 0.50 to 1.2 dL/g, or 0.55 to 1.2 dL/g, or 0.60 to 1.2 dL/g, or 0.65 to 1.2 dL/g, or 0.65 to 0.90 dL/g, as determined in 60/40 (wt/wt) phenol/tetrachloroethane at a concentration of 0.5 g/100 ml at 25° C.

In one embodiment, a polyester composition is provided comprising:
(1) at least one polyester which comprises:
   (a) a dicarboxylic acid component comprising:
      (i) about 70 to about 100 mole % residues of terephthalic acid or esters thereof;
      (ii) about 0 to about 30 mole % of aromatic or aliphatic dicarboxylic acid residues, or combinations thereof, having up to 20 carbon atoms;
   (b) a glycol component comprising:
      (i) about 50 to about 100 mole % of ethylene glycol residues;
      (ii) about 0 to about 50 mole % residues of modifying glycols comprising linear or alicyclic residues containing 2 to 20 carbon atoms;
   wherein the total mole % of the dicarboxylic acid component is 100 mole %,
   wherein the total mole % of the diol component is 100 mole %; and
(2) residues of a metal catalyst system consisting essentially of or consisting of germanium atoms in the amount of less than 30 ppm, or less than 25 ppm, or less than 20 ppm, or less than 15 ppm, or 10 ppm or less, or 5 ppm or less, or less than 5 ppm, relative to the mass of final polyester being prepared; and
   wherein the inherent viscosity of the final polyester is 0.35 to 1.2 dL/g, or 0.45 to 1.2 dL/g, or 0.50 to 1.2 dL/g, or 0.55 to 1.2 dL/g, or 0.60 to 1.2 dL/g, or 0.65 to 1.2 dL/g, or 0.65 to 0.90 dL/g, as determined in 60/40 (wt/wt) phenol/tetrachloroethane at a concentration of 0.5 g/100 ml at 25° C.

In one embodiment, a polyester composition is provided comprising:
(1) at least one polyester which comprises:
   (a) a dicarboxylic acid component comprising:
      (i) about 70 to about 100 mole % residues of terephthalic acid or esters thereof;
      (ii) about 0 to about 30 mole % of aromatic or aliphatic dicarboxylic acid residues, or combinations thereof, having up to 20 carbon atoms;
   (b) a glycol component comprising:
      (i) about 50 to about 100 mole % of ethylene glycol residues;
      (ii) about 0 to about 50 mole % residues of modifying glycols comprising linear or alicyclic residues containing 2 to 20 carbon atoms;
   wherein the total mole % of the dicarboxylic acid component is 100 mole %,
   wherein the total mole % of the diol component is 100 mole %; and
(2) residues of a metal catalyst system consisting essentially of or consisting of germanium atoms in the amount of 5 ppm or less, or less than 5 ppm, relative to the mass of final polyester being prepared; and
   wherein the inherent viscosity of the final polyester is 0.35 to 1.2 dL/g, or 0.45 to 1.2 dL/g, or 0.50 to 1.2 dL/g, or 0.55 to 1.2 dL/g, or 0.60 to 1.2 dL/g, or 0.65 to 1.2 dL/g, or 0.65 to 0.90 dL/g, as determined in 60/40 (wt/wt) phenol/tetrachloroethane at a concentration of 0.5 g/100 ml at 25° C.

In one embodiment, for the glycol component, the modifying glycols can comprise at least one of diethylene glycol, 1,2-propanediol, 1,3-propanediol, 2-methyl-1,4-cyclohexanedimethanol (CHDM), 2,2,4,4-tetramethyl-1,3-1,3-propanediol, cyclobutanediol (TMCD), 1,4-butanediol, 1,5-pentanediol, 1,6-hexanediol, p-xylene glycol, neopentyl glycol, isosorbide, polytetramethylene glycol, or mixtures thereof.

In one embodiment, the polyesters and/or the polyester compositions of the invention can comprise residues of TMCD or CHDM in the amount of from about 10 to about 50 mole %, or from about 10 to about 45 mole %, or from about 10 to about 40 mole %, or from about 10 to about 35 mole %, or from about 15 to about 45 mole %, or from about 15 to about 40 mole %, or from about 15 to about 35 mole %, or from about 20 to about 45 mole %, or from about 20 to about 40 mole %, or from about 20 to about 35 mole %, or from about 25 to about 45 mole %, or from about 25 to about 40 mole %. Other modifying glycols can comprise the remaining mole percentages.

In one embodiment, the polyesters and/or the polyester compositions of the invention can comprise EG residues in the amount of from about 50 to about 90 mole %, or from 55 to about 90 mole %, or from about 60 to about 90 mole %, or from about 65 to about 90 mole %, or from about 55 to about 85 mole %, or from about 60 to about 85 mole %, or from about 65 to about 85 mole %, or from about 55 to about 80 mole %, or from about 60 to about 80 mole %, or from about 65 to about 80 mole %, or from about 60 to about 75 mole %.

In one embodiment, at least one polyester made by the process(es) of the invention can comprise residues of TMCD in the amount of 20 to 45 mole % and residues of EG in the amount of 55 to 80 mole %, or residues of TMCD in the amount of 20 to 40 mole % and residues of EG in the amount of 60 to 80 mole %, or residues of TMCD in the amount of 20 to 35 mole % and residues of EG in the amount of 65 to 80 mole %, or 25 to 45 mole % and residues of EG in the amount of 55 to 75 mole %, or residues of TMCD in the amount of 25 to 40 mole % and residues of EG in the amount of 60 to 75 mole %, or residues of TMCD in the amount of 25 to 35 mole % and residues of EG in the amount of 65 to 75 mole %; or residues of TMCD in the amount of 30 to 35 mole % and residues of EG in the amount of 65 to 70 mole %, based on the total mole percentages of glycol residues in the final polyester equaling 100 mole %.

In one embodiment, at least one polyester made by the process(es) of the invention can comprise residues of CHDM in the amount of 20 to 45 mole % and residues of EG in the amount of 55 to 80 mole %, or residues of CHDM in the amount of 20 to 40 mole % and residues of EG in the amount of 60 to 80 mole %, or residues of CHDM in the amount of 20 to 35 mole % and residues of EG in the amount of 65 to 80 mole %, or residues of CHDM in the amount of 25 to 45 mole % and residues of EG in the amount of 55 to 75 mole %, or residues of CHDM in the amount of 25 to 40 mole % and residues of EG in the amount of 60 to 75 mole %, or residues of CHDM in the amount of 25 to 35 mole % and residues of EG in the amount of 65 to 75 mole %; or residues of CHDM in the amount of 30 to 35 mole % and residues of EG in the amount of 65 to 70 mole %, based on the total mole percentages of glycol residues in the final polyester equaling 100 mole %.

In one embodiment, the polyesters and/or the polyester compositions of the invention can comprise no residues of CHDM, or not more than 10 mole %, or not more than 5 mole % of CHDM residues, based on the total mole percentages of glycol residues in the final polyester equaling 100 mole %.

In one embodiment, the polyesters and/or the polyester compositions of the invention can comprise residues of ethylene glycol in the amount of from about 60 to about 100 mole %, or from about 60 to about 90 mole %, or from about 65 to about 90 mole %, or from about 70 to about 90 mole %, based on the total mole percentages of glycol residues in the final polyester equaling 100 mole %.

In one embodiment, the polyesters and/or the polyester compositions of the invention can comprise residues of ethylene glycol and no residues of CHDM, or not more than 10 mole %, or not more than 5 mole % of CHDM residues, wherein the remaining modifying glycols optionally comprise at least one of diethylene glycol, 1,2-propanediol, 1,3-propanediol, 1,4-butanediol, 2-methyl-1,3-propanediol, 1,5-pentanediol, 1,6-hexanediol, p-xylene glycol, neopentyl glycol, isosorbide, polytetramethylene glycol, or mixtures thereof.

In one embodiment, the polyesters and/or the polyester compositions of the invention can comprise residues of at least one of 1,3-propanediol, 1,4-butanediol, and NPG.

In other embodiments, the glycol component for the polyesters and/or polyester compositions can include any of the following ranges: about 10 to about 27 mole % TMCD and about 90 to about 73 mole % ethylene glycol; about 15 to about 26 mole % TMCD and about 85 to about 74 mole % ethylene glycol; about 18 to about 26 mole % TMCD and about 82 to about 77 mole % ethylene glycol; about 20 to about 25 mole % TMCD and about 80 to about 75 mole % ethylene glycol; about 21 to about 24 mole % TMCD and about 79 to about 76 mole % ethylene glycol; or about 22 to about 24 mole % TMCD and about 78 to about 76 mole % ethylene glycol, based on the total mole percentages of glycol residues in the final polyester equaling 100 mole %. In this embodiment, diethylene glycol can be present, either added or formed in situ. If formed in situ, diethylene glycol can present in an amount up to 5 mole %, up to 4, up to 3, and up to 2 mole %

In other embodiments, the glycol component for the polyesters and/or polyester compositions can include any of the following ranges: 15 to 27 mole % TMCD and 73 to 85 mole % ethylene glycol; 18 to 27 mole % TMCD and 73 to 82 mole % ethylene glycol; 19 to 26 mole % TMCD and 74 to 81 mole % ethylene glycol; 20 to 25 mole % TMCD and 75 to 80 mole % ethylene glycol, based on the total mole percentages of glycol residues in the final polyester equaling 100 mole %.

In one embodiment, the polyester can comprise: a glycol component that includes 15 to 27 mole % TMCD and 73 to 85 mole % ethylene glycol, an inherent viscosity of 0.60 to 0.70 dL/g and a Tg of 90 to 96° C.; or a glycol component that includes 20 to 25 mole % TMCD and 75 to 80 mole % ethylene glycol, an inherent viscosity of 0.63 to 0.67 dL/g and a Tg of 92 to 94° C.

For the desired polyester, the molar ratio of cis/trans TMCD and of cis/trans CHDM can vary from the pure form of each and combinations thereof.

In one embodiment, terephthalic acid may be used as the starting material. In another embodiment, dimethyl terephthalate may be used as the starting material. In yet another embodiment, mixtures of terephthalic acid and dimethyl terephthalate may be used as the starting material and/or as an intermediate material.

In certain embodiments, terephthalic acid or an ester thereof, such as, for example, dimethyl terephthalate or a mixture of terephthalic acid residues and an ester thereof can make up a portion or all of the dicarboxylic acid component used to form the polyesters and/or polyester compositions of the invention. In certain embodiments, terephthalic acid residues can make up a portion or all of the dicarboxylic acid component used to form the polyesters and/or polyester compositions of the invention. In certain embodiments, higher amounts of terephthalic acid can be used in order to produce a higher impact strength polyester. For purposes of this disclosure, the terms “terephthalic acid” and “dimethyl terephthalate” are used interchangeably herein. In one embodiment, dimethyl terephthalate is part, or all of the dicarboxylic acid component used to make the polyesters useful in the present invention. In certain embodiments, ranges of from 70 to 100 mole %; or 80 to 100 mole %; or 90 to 100 mole %; or 99 to 100 mole %; or 100 mole % terephthalic acid and/or dimethyl terephthalate and/or mixtures thereof may be used. In addition to terephthalic acid or esters thereof, such as dimethyl terephthalate, the dicarboxylic acid component of the polyesters of the invention can comprise less than 30 mole %, or less than 20 mole %, or less than 10 mole %, or less than 5 mole %, or from 0 to 30 mole %, or from 0 to 20 mole %, or from 0 to 10 mole %, or from 0 to 5 mole %, or from 0 to 1 mole %, or 0.01 to 10 mole %, or 0.1 to 10 mole %, or 1 or 10 mole %, or 0.01 to 5 mole %, or 0.1 to 5 mole %, or 1 or 5, or 0.01 to 1 mole %, or 0.1 to 1 mole %, or 5 to 10 mole %, or 0 mole % of one or more modifying aromatic dicarboxylic acids. Yet another embodiment contains 0 mole % modifying aromatic dicarboxylic acids. Thus, if present, it is contemplated that the amount of one or more modifying aromatic dicarboxylic acids can range from any of these preceding endpoint values including, for example, 0.01 to 10 mole %, from 0.01 to 5 mole % and from 0.01 to 1 mole %. In one embodiment, modifying aromatic dicarboxylic acids that may be used in the present invention include but are not limited to those having up to 20 carbon atoms, and which can be linear, para-oriented, or symmetrical. Examples of modifying aromatic dicarboxylic acids which may be used in this invention include, but are not limited to, isophthalic acid, 4,4′-biphenyldicarboxylic acid, 1,4-, 1,5-, 2,6-, 2,7-naphthalenedicarboxylic acid, and trans-4,4′-stilbenedicarboxylic acid, and esters thereof. In one embodiment, the modifying aromatic dicarboxylic acid is isophthalic acid.

In addition to terephthalic acid or esters thereof, such as dimethyl terephthalate, the dicarboxylic acid component of the polyesters of the invention can comprise less than 30 mole %, or less than 20 mole %, or less than 10 mole %, or less than 5 mole %, or from 0 to 30 mole %, or from 0 to 20 mole %, or from 0 to 10 mole %, or from 0 to 5 mole %, or from 0 to 1 mole %, or 0.01 to 10 mole %, or 0.1 to 10 mole %, or 1 or 10 mole %, or 0.01 to 5 mole %, or 0.1 to 5 mole %, or 1 or 5, or 0.01 to 1 mole %, or 0.1 to 1 mole %, or 5 to 10 mole %, or 0 mole % of one or more modifying aromatic dicarboxylic acids. Yet another embodiment contains 0 mole % modifying aromatic dicarboxylic acids. Thus, if present, it is contemplated that the amount of one or more modifying aromatic dicarboxylic acids can range from any of these preceding endpoint values including, for example, 0.01 to 10 mole %, from 0.01 to 5 mole % and from 0.01 to 1 mole %. In one embodiment, modifying aromatic dicarboxylic acids that may be used in the present invention include but are not limited to those having up to 20 carbon atoms, and which can be linear, para-oriented, or symmetrical. Examples of modifying aromatic dicarboxylic acids which may be used in this invention include, but are not limited to, isophthalic acid, 4,4′-biphenyldicarboxylic acid, 1,4-, 1,5-, 2,6-, 2,7-naphthalenedicarboxylic acid, and trans-4,4′-stilbenedicarboxylic acid, and esters thereof. In one embodiment, the modifying aromatic dicarboxylic acid is isophthalic acid.

The carboxylic acid component of the polyesters and/or polyester compositions of the invention can be further modified with less than 30 mole %, or less than 20 mole %, or less than 10 mole %, or less than 5 mole %, or from 0 to 30 mole %, or from 0 to 20 mole %, or from 0 to 10 mole %, or from 0 to 5 mole %, or from 0 to 1 mole %, or 0.01 to 10 mole %, or 0.1 to 10 mole %, or 1 or 10 mole %, or 0.01 to 5 mole %, or 0.1 to 5 mole %, or 1 or 5, or 0.01 to 1 mole %, or 0.1 to 1 mole %, or 5 to 10 mole %, or 0 mole % of one or more aliphatic dicarboxylic acids containing 2-16 carbon atoms, such as, for example, cyclohexanedicarboxylic, malonic, succinic, glutaric, adipic, pimelic, suberic, azelaic and dodecanedioic dicarboxylic acids. Certain embodiments can also comprise 0.01 to 10 mole %, such as 0.1 to 10 mole %, 1 or 10 mole %, 5 to 10 mole % of one or more modifying aliphatic dicarboxylic acids. Yet another embodiment contains 0 mole % modifying aliphatic dicarboxylic acids. The total mole % of the dicarboxylic acid component is 100 mole %. In one embodiment, adipic acid and/or glutaric acid are provided in the modifying aliphatic dicarboxylic acid component of the invention.

Esters of terephthalic acid and the other modifying dicarboxylic acids or their corresponding esters and/or salts may be used instead of the dicarboxylic acids. Suitable examples of dicarboxylic acid esters include, but are not limited to, the dimethyl, diethyl, dipropyl, diisopropyl, dibutyl, and diphenyl esters. In one embodiment, the esters are chosen from at least one of the following: methyl, ethyl, propyl, isopropyl, and phenyl esters.

In one embodiment, a polyester composition is provided wherein said polyester comprises from about 80 to about 100 mole %, or to about 90 to about 100 mole %, or about 95 to about 100 mole %, or about 99 to about 100 mole %, of residues of terephthalic acid or ester(s) thereof;

In one embodiment, the polyesters and/or polyester compositions of the invention can comprise CHDA in an amount of less than 30 mole %, or less than 20 mole %, or less than 10 mole %, or less than 5 mole %, or from 0 to 30 mole %, or from 0 to 20 mole %, or from 0 to 10 mole %, or from 0 to 5 mole %, or from 0 to 1 mole %, or 0.01 to 10 mole %, or 0.1 to 10 mole %, or 1 or 10 mole %, or 0.01 to 5 mole %, or 0.1 to 5 mole %, or 1 or 5, or 0.01 to 1 mole %, or 0.1 to 1 mole %, or 5 to 10 mole %, or 0 mole %, based on the total mole percentages of diacid residues in the final polyester equaling 100 mole %.

In one embodiment, the polyesters and/or polyester compositions of the invention can comprise trans-CHDA in an amount of less than 30 mole %, or less than 20 mole %, or less than 10 mole %, or less than 5 mole %, or from 0 to 30 mole %, or from 0 to 20 mole %, or from 0 to 10 mole %, or from 0 to 5 mole %, or from 0 to 1 mole %, or 0.01 to 10 mole %, or 0.1 to 10 mole %, or 1 or 10 mole %, or 0.01 to 5 mole %, or 0.1 to 5 mole %, or 1 or 5, or 0.01 to 1 mole %, or 0.1 to 1 mole %, or 5 to 10 mole %, or 0 mole %, based on the total mole percentages of diacid residues in the final polyester equaling 100 mole %.

The reported amount of a metal or germanium (e.g., ppm) is based on the amount of the atom present in the solution, polymer, or article and not the amount of the compound or salt, unless expressly stated as the amount of the compound or salt.

In one embodiment, the polyester composition of the invention comprises at least one germanium compound.

In one embodiment, the polyester composition of the invention comprises at least one germanium compound is selected from germanium alkoxides, germanium carboxylates, germanium glycolates, organogermanium compounds, or esters of germanic acid.

In one embodiment, the polyester composition of the invention comprises at least one germanium compound is selected from germanium alkoxides and carboxylates.

In one embodiment, the polyester composition of the invention comprises germanium ethoxide, germanium isopropoxide, and germanium acetate, or germanium dioxide.

The germanium compound must be present in the finisher, and desirably present in a prepolymerization zone and a finishing zone. The germanium catalyst can be added, for example, after the intrinsic viscosity of the polymer reaches 0.2 dL/g. However, it may also be added prior to the or near the start of the polycondensation zone, and this mode of addition is preferred, particularly as the polycondensation rate will be much faster in the presence of germanium catalyst, and as the prefinishing stages operate at lower temperatures and higher pressure (lower vacuum). For example, germanium catalyst can be added between the end of the esterification zone and the start of the polycondensation zone. A single addition or multiple additions may be employed.

The term “residues of a metal catalyst system consisting essentially of”, means that another catalyst cannot be present in amount over 5 ppm, where the weight of the germanium catalyst is calculated as weight of germanium atoms relative to the total weight of the ingredients introduced into the polycondensation zone.

Germanium catalysts can include ones, such as germanium dioxide in the crystalline and amorphous state or solutions obtained by dissolving germanium dioxide, in glycol or in other solution and, on the other hand, can include organogermanium compounds or various esters of germanic acid.

The oligomeric ethylene terephthalates to be polycondensed in accordance with the invention are produced in a conventional manner, either by the esterification of terephthalic acid with excess ethylene glycol or by the interesterification of terephthalic acid esters, preferably dimethyl terephthalate, with excess ethylene glycol and as described in U.S. Pat. No. 3,651,018.

The polycondensation process is performed in a finishing reactor. The finishing reactor is the reactor, such as the final reactor, used in the polycondensation process for increasing the molecular weight of the polymer in the melt before solidification. In one embodiment, the finishing reactor is the final reactor used in the polycondensation process for increasing the molecular weight of the polymer in the melt before solidification.

The polyester polymer melt is polycondensed in the finisher reactor/zone in the presence of at least 20 ppm, or at least 30 ppm, or at least 50 ppm germanium catalyst (added prior to, at, or in the finisher reactor), calculated as weight of germanium atoms relative to the total weight of the ingredients introduced into the polycondensation zone. The amount of germanium catalyst introduced to the polycondensation zone can be in the amount of from 20 to 500 ppm, or from 20 to 450 ppm, or from 20 to 400 ppm, or from 20 to 350 ppm, or from 20 to 300 ppm, or from 20 to 250 ppm, or from 50 to 500 ppm, or from 50 to 450 ppm, or from 50 to 400 ppm, or from 50 to 350 ppm, or from 50 to 300 ppm, or from 50 to 250 ppm, or from 100 to 500 ppm, or from 100 to 450 ppm, or from 20 to 400 ppm, or from 100 to 350 ppm, or from 100 to 300 ppm, or from 100 to 250 ppm, or from 150 to 500 ppm, or from 150 to 450 ppm, or from 150 to 400 ppm, or from 150 to 350 ppm, or from 150 to 300 ppm, or from 150 to 250 ppm, or from 175 to 500 ppm, or from 175 to 450 ppm, or from 175 to 400 ppm, or from 175 to 350 ppm, or from 175 to 300 ppm, or from 175 to 250 ppm, or from 200 to 500 ppm, or from 200 to 450 ppm, or from 200 to 400 ppm, or from 200 to 350 ppm, or from 200 to 300 ppm, or from 200 to 250 ppm.

The polyester polymer melt is polycondensed in the finisher reactor/zone in the presence of germanium catalyst (added prior to, at, or in the finisher reactor but after 90% conversion during esterification is obtained or after an esterification zone and before the finisher or final polycondensation reactor), calculated as weight of germanium atoms.

In one embodiment, any of the polyesters and/or polyester compositions of the invention can have an inherent viscosity selected from within one of the following ranges: from 0.45 to 1.2 dL/g, or from 0.45 to 1.0 dL/g, or from 0.45 to 0.90 dL/g, or from 0.45 to 0.85 dL/g, or from 0.45 to 0.80 dL/g, or from 0.45 to 0.75 dL/g, or from 0.45 to 0.70 dL/g, or from 0.50 to 1.2 dL/g, or from 0.50 to 1.0 dL/g, or from 0.50 to 0.90 dL/g, or from 0.50 to 0.85 dL/g, or from 0.50 to 0.80 dL/g, or from 0.50 to 0.75 dL/g, or from 0.50 to 0.70 dL/g, or from 0.55 to 1.2 dL/g, or from 0.55 to 1.0 dL/g, or from 0.55 to 0.90 dL/g, or from 0.55 to 0.85 dL/g, or from 0.55 to 0.80 dL/g, or from 0.55 to 0.75 dL/g, or from 0.55 to 0.70 dL/g, or 0.60 to 1.2 dL/g, or from 0.60 to 1.0 dL/g, or from 0.60 to 0.90 dL/g, or from 0.60 to 0.85 dL/g, or from 0.60 to 0.80 dL/g, or from 0.60 to 0.75 dL/g, or from 0.60 to 0.70 dL/g, or from 0.65 to 1.2 dL/g, or from 0.65 to 1.0 dL/g, or from 0.65 to 0.90 dL/g, or from 0.65 to 0.85 dL/g, or from 0.65 to 0.80 dL/g, or from 0.65 to 0.75 dL/g, or from 0.68 to 1.2 dL/g, or from 0.60 to 1.0 dL/g, or from 0.68 to 0.90 dL/g, or from 0.68 to 0.85 dL/g, or from 0.68 to 0.80 dL/g, as determined in 60/40 (wt/wt) phenol/tetrachloroethane at a concentration of 0.5 g/100 ml at 25° C.

In one embodiment, a polyester composition is provided wherein the inherent viscosity of the polyester can be from 0.45 to 1.2 dL/g, or from 0.45 to 1.0 dL/g, or from 0.45 to 0.85 dL/g, or from 0.45 to 0.80 dL/g, or from 0.55 to 1.2 dL/g, or from 0.55 to 1.0 dL/g, or from 0.55 to 0.85 dL/g, or from 0.65 to 1.2 dL/g, or from 0.65 to 1.0 dL/g, or from 0.65 to 0.85 dL/g, or from 0.65 to 0.80 dL/g, or from 0.65 to 0.75 dL/g, or from 0.60 to 1.2 dL/g, or from 0.60 to 1.0 dL/g, or from 0.60 to 0.85 dL/g, or from 0.60 to 0.80 dL/g, or from 0.60 to 0.75 dL/g, or from 0.68 to 0.85 dL/g, as determined in 60/40 (wt/wt) phenol/tetrachloroethane at a concentration of 0.5 g/100 ml at 25° C.

In one embodiment, a polyester composition is provided wherein less than 70 ppm, or less than 65 ppm, or less than 60 ppm, or less than 55 ppm, or less than 50 ppm, or less than 45 ppm, or less than 40 ppm, or less than 35 ppm, or less than 30 ppm, or less than 25 ppm, or less than 20 ppm, or less than 15 ppm, or 10 ppm or less, or 25 ppm or less, or 20 ppm or less of germanium atoms are present in the final polyester composition.

In one embodiment, a polyester composition is provided wherein the inherent viscosity of the polyester is 0.50 to 1.2 dL/g, or from 0.50 to 1.0 dL/g, or from 0.50 to 0.90 dL/g, or from 0.50 to 0.85 dL/g, or from 0.50 to 0.80 dL/g, or from 0.50 to 0.80 dL/g, and the amount of germanium atoms present in the final polyester composition is 18 ppm or less, or 15 ppm or less, or 10 ppm or less, or 5 ppm or less.

In one embodiment, a polyester composition is provided wherein the inherent viscosity of the polyester is from 0.60 to 1.2 dL/g, or from 0.60 to 1.0 dL/g, or from 0.60 to 0.90 dL/g, or from 0.60 to 0.85 dL/g, or from 0.65 to 1.2 dL/g, or from 0.65 to 1.0 dL/g, or from 0.65 to 0.90 dL/g, or from 0.65 to 0.85 dL/g.

In one embodiment, a polyester composition is provided wherein the amount of germanium atoms present in the final polyester composition is 20 ppm or less, or 18 ppm or less, or 15 ppm or less, or 10 ppm or less, or 5 ppm or less.

In one embodiment, a polyester composition is provided wherein the amount of germanium atoms present in the final polyester composition is 5 ppm or less, or less than 5 ppm, or less than 4 ppm, or less than 3 ppm, or less than 2 ppm, or less than 1 ppm, or 0 ppm.

Inherent viscosity is determined herein in 60/40 (wt/wt) phenol/tetrachloroethane at a concentration of 0.5 g/100 ml at 25° C.

The inherent viscosity can be measured either on the particles, amorphous or crystallized, obtained after a cutter fed by the polymer melt exiting the finisher reactor without subjecting the particle to any processes which further increase their molecular weight, or by taking a sample from the discharge of the finisher reactor.

In one embodiment, a process is provided for making any of the polyesters of the invention.

In one embodiment, the ability to remove catalyst during the polycondensation reaction is enhanced by the process of the invention, thus resulting in minimal to no catalyst in the final product. Catalyst recovery from the finisher can be recycled and reused for other purposes. In one embodiment, the loss of catalyst or removal of catalyst occurs in the finisher or finishing reactor and/or not in a post-finishing stage.

In this invention, the greater the “loss of catalyst” is, the better the process is believed to be. “Loss of catalyst” is defined in this invention as total amount of catalyst ceasing to be in the reactor and is further defined below, e.g., by removal or loss of catalyst from the reaction thus resulting in lower catalyst levels in the final polyester composition. The percentage of germanium loss is calculated by subtracting the amount of remaining germanium measured in the final polymer from the amount of germanium added just prior to the finisher and/or to the finisher, dividing the difference by the amount of germanium added just prior to the finisher, and multiplying the quotient by 100.

In one embodiment, a process is provided for making any of the polyesters of the invention wherein the loss of catalyst or removal of catalyst is greater than 70%, or greater than 75%, or greater than 80%, or greater than 85%, or greater than 86%, or greater than 87%, or greater than 88%, or greater than 89%, or greater than 90%, or greater than 95%, or greater than 96%, or greater than 97%, or greater than 98%, or greater than 99%.

In one embodiment, a process is provided for making any of the polyesters of the invention wherein said loss of catalyst or removal of catalyst can occur by application of vacuum, by nitrogen purge, or a combination thereof, or by any other means known to one of ordinary skill in the art. Removal of germanium catalyst by in the finisher reactor, (optionally, not in a post-finisher reactor, reaction or step), can be accomplished by removing catalyst from the finisher reactor either at a single time in the process or at multiple intervals of time throughout the process in the finisher reactor so that germanium may be recovered and preferably recycled. The removal of catalyst in the finisher reactor without the need for removal later and without the need for additional steps for removal is one of the benefits of this invention.

In one embodiment, a process is provided for making any of the polyesters of the invention wherein said processes take place in at least one finishing reactors selected from thin film reactors or vertical finishing reactors. These reactors can include, but are not limited, to falling film evaporators, falling film reactors, zimmer (horizontal) finishers, and tray finishers, other horizontal type finishers, for example, horizontal cylindrical reactors (see U.S. Pat. No. 3,728,083A, incorporated herein by reference, which describes reactors where wagon wheels pull up and make a thin polymer film from which volatile compounds like ethylene glycol and, in this case, germanium, could be removed). Also, for example, see U.S. Pat. No. 4,196,168A, incorporated herein by reference. The above listed reactors are examples only, any reactor having a reactor design with a high surface area to volume ratio (for example, thin film) can be used in this invention.

In one embodiment, the invention provides a process wherein the dihydroxy terephthalate-containing compound (e.g., BHET or oligomers thereof) can be added to a finishing reactor that has features providing a high surface area to volume ratio.

In one embodiment, a process is provided for making any of the polyesters of the invention wherein at least one dihydroxy terephthalate-containing compound is fed to a finishing reactor operating in the range of 180° C. to 300° C., or 180° C. to 285° C., with vacuum levels between 0.1-5 torr and a total process time of from 15 minutes to 8 hours wherein germanium is a catalyst and wherein the final product has an inherent viscosity of at least 0.45 dL/g, or from 0.45 to 1.2 dL/g, or from 0.50 to 1.2 dL/g, or from 0.55 to 1.2 dL/g, or from 0.60 to 1.2 dL/g, or from 0.65 to 1.2 dL/g, or from 0.65 to 0.90 dL/g, and contains less than 75 ppm germanium atoms.

In one embodiment, a process is provided for making any of the polyesters of the invention wherein at least one dihydroxy terephthalate-containing compound is fed to a finishing reactor operating in the range of 240° C.-300° C., or 240° C.-285° C., with vacuum levels between 0.1-5 torr and a total process time of from 15 minutes to 8 hours wherein germanium is a catalyst and wherein the final product has an inherent viscosity of at least 0.65 dL/g and contains less than 75 ppm germanium atoms.

In one embodiment, a process is provided for making any of the polyesters of the invention wherein at least one dihydroxy terephthalate-containing compound is fed to a finishing reactor operating in the range of 240° C.-300°, or 240° C.-285,° C. with vacuum levels between 0.1-1 torr and a total process time of from 15 minutes to 8 hours wherein germanium is a catalyst and wherein the final product has an inherent viscosity of at least 0.65 dL/g and contains less than 75 ppm, or less than 50 ppm, or less 25 ppm, or less than 15 ppm, or less than 10 ppm, of germanium atoms.

In one embodiment, a process is provided for making any of the polyesters of the invention wherein the dihydroxy terephthalate-containing compound comprises:

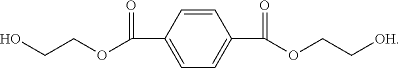 [SMILES: O=C(OCCO)c1ccc(C(=O)OCCO)cc1]

In one embodiment, a process is provided for making any of the polyesters of the invention wherein the dihydroxy terephthalate-containing compound, and optionally, at least one modifying diol, is reacted in the presence of a single polycondensation catalyst consisting essentially of or consisting of germanium atoms.

In one embodiment, a process is provided for making any of the polyesters of the invention wherein the dihydroxy terephthalate-containing compound is bis-2-hydroxyethyl terephthalate (BHET).

In one embodiment, a process is provided for making any of the polyesters of the invention wherein 1,4-cyclohexanedimethanol is a modifying glycol.

In one embodiment, a process is provided for making any of the polyesters of the invention wherein is 2,2,4,4-tetramethyl-1,3-cyclobutanediol is a modifying glycol.

In one embodiment, the processes of the invention can be conducted at a temperature of from 180° C. to 300° C., or from 200° C. to 300° C.; or from 200° C. to 285° C.; or from 200° C. to 280° C.; or from 200° C. to 275° C.; or from 200° C. to 270° C.; or from 225° C. to 300° C.; or from 225° C. to 285° C.; or from 225° C. to 280° C.; or from 245° C. to 280° C.; or from 245° C. to 275° C.; or at or below 280° C., or at or below 275° C., or from 240° C. to 300° C., or from 240° C. to 290° C., or from 240° C. to less than 290° C., or from 240° C. to 285° C., or from 260° C. to 290° C., or from 260° C. to less than 290° C., or from 260° C. to 285° C., or from 270° C. to 290° C., or from 270° C. to less than 290° C., or from 270° C. to 285° C., or from 270° C. to 280° C., or from greater than 270° C. to 290° C., or from greater than 270° C. to less than 290° C., or from greater than 270° C. to 285° C., or from greater than 270° C. to 280° C., at a total process time of from 0.10 to 12 hours, or from 0.10 to 8 hours, or from 0.10 to 5 hours, or from 0.10 to 4 hours, or from 0.10 to 3 hours, to from 0.10 to 2 hours, or from 0.25 to 8 hours, or from 0.25 to 7 hours, or from 0.25 to 6 hours, or from 0.25 to 5 hours, or from 0.25 to 4 hours, or from 0.25 to 3 hours, to from 0.25 to 2 hours.

In one embodiment, the processes of the invention can be conducted at a temperature of from 240° C. to 290° C., or from 240° C. to less than 290° C., or from 240° C. to 285° C., or from 260° C. to 290° C., or from 240° C. to 285° C., or from 260° C. to 290° C., or from 260° C. to less than 290° C., or from 260° C. to 285° C., or from 270° C. to 290° C., or from 270° C. to less than 290° C., or from 270° C. to 285° C., or from 270° C. to 280° C., at a total process time of from 0.25 to 8 hours.

In one embodiment, the processes of the invention can be carried out at a pressure of from 0.10 to 5 torr, or from 0.10 to 4 torr, or from 0.10 to 3 torr, or from 0.10 to 2 torr, or from 0.10 to 1 torr.

In some embodiments, the polyesters according to the invention can comprise from 0 to 10 mole percent, for example, from 0.01 to 5 mole percent, from 0.01 to 1 mole percent, from 0.05 to 5 mole percent, from 0.05 to 1 mole percent, or from 0.1 to 0.7 mole percent, based the total mole percentages of either the diol or diacid residues; respectively, of one or more residues of a branching monomer, also referred to herein as a branching agent, having 3 or more carboxyl substituents, hydroxyl substituents, or a combination thereof. In certain embodiments, the branching monomer or agent may be added prior to and/or during and/or after the polymerization of the polyester. In embodiments, the polyester(s) useful in the invention can thus be linear or branched.

Examples of branching monomers include, but are not limited to, multifunctional acids or multifunctional alcohols such as trimellitic acid, trimellitic anhydride, pyromellitic dianhydride, trimethylolpropane, glycerol, pentaerythritol, citric acid, tartaric acid, 3-hydroxyglutaric acid and the like. In one embodiment, the branching monomer residues can comprise 0.1 to 0.7 mole percent of one or more residues chosen from at least one of the following: trimellitic anhydride, pyromellitic dianhydride, glycerol, sorbitol, 1,2,6-hexanetriol, pentaerythritol, trimethylolethane, and/or trimesic acid. The branching monomer may be added to the polyester reaction combination or blended with the polyester in the form of a concentrate as described, for example, in U.S. Pat. Nos. 5,654,347 and 5,696,176, whose disclosure regarding branching monomers is incorporated herein by reference.

The polyesters of the invention can comprise at least one chain extender. Suitable chain extenders include, but are not limited to, multifunctional (including, but not limited to, bifunctional) isocyanates, multifunctional epoxides, including for example epoxylated novolacs, and phenoxy resins. In certain embodiments, chain extenders may be added at the end of the polymerization process or after the polymerization process. If added after the polymerization process, chain extenders can be incorporated by compounding or by addition during conversion processes such as injection molding or extrusion. The amount of chain extender used can vary depending on the specific monomer composition used and the physical properties desired but is generally about 0.1 percent by weight to about 10 percent by weight, such as about 0.1 to about 5 percent by weight, based on the total weight of the polyester.

In one embodiment, certain polyesters useful in this invention can be visually clear. The term “visually clear” is defined herein as an appreciable absence of cloudiness, haziness, and/or muddiness, when inspected visually.

In one embodiment, the polyesters and/or polyester compositions of the invention, [in one embodiment, in the presence of and/or in the absence of toner(s)], can have color values L*, a* and b* which can be determined using a Hunter Lab Ultrascan Spectra Colorimeter manufactured by Hunter Associates Lab Inc., Reston, Va. The color determinations are averages of values measured on either pellets of the polyesters or plaques or other items injection molded or extruded from them. They are determined by the L*a*b* color system of the CIE (International Commission on Illumination) (translated), wherein L* represents the lightness coordinate, a* represents the red/green coordinate, and b* represents the yellow/blue coordinate.

In certain embodiments of the invention, the Tg of the polyesters can be chosen from one of the following ranges: from 72 to 100° C., or from 85 to 100° C., or from 90 to 100° C. For TMCD-EG polyesters, the Tg can be one of the following ranges: 85 to 100° C.; 86 to 99° C.; 87 to 98° C.; 88 to 97° C.; 89 to 96° C.; 90 to 95° C.; 91 to 95° C.; 92 to 94° C. The glass transition temperature (Tg) of the polyesters is determined using a TA DSC 2920 from Thermal Analyst Instrument at a scan rate of 20° C./min.

It is contemplated that compositions useful in the invention can possess at least one of the inherent viscosity ranges described herein and at least one of the monomer ranges for the compositions described herein unless otherwise stated. It is also contemplated that compositions useful in the invention can possess at least one of the Tg ranges described herein and at least one of the monomer ranges for the compositions described herein unless otherwise stated. It is also contemplated that compositions useful in the invention can possess at least one of the inherent viscosity ranges described herein, at least one of the Tg ranges described herein, and at least one of the monomer ranges for the composition.

The melt phase process employs an esterification or ester exchange zone and a polycondensation zone. Glycol and acid are first esterified, most often with an excess of glycol, to prepare low molecular weight esters and oligomers in an esterification zone, typically having an average DP based on the number average molecular weight ranging from 2 to 20, or 2 to 10, or 2 to 5. This reaction is often uncatalyzed in a direct esterification process. Following completion of esterification, in one embodiment, to at least 80% conversion, or, in one embodiment, to at least 90% conversion, the monomer mixture is removed from the esterification zone and fed to the polycondensation zone. Polycondensation is typified by commencing the application of vacuum, and/or the predominance of removing the alkylene glycol to build up molecular weight, such as ethylene glycol. In some processes, polycondensation may be conceptually divided into numerous substages, such as “prepolymerization,” and “finishing,” but the terms used in the industry are not consistent. In most processes, polycondensation takes place in a plurality of reactors, or in reactors containing a plurality of reaction zones. As the polymer is subjected to polycondensation and passes on to subsequent reactors and/or reaction zones, the temperature and amount of vacuum applied generally increases to drive the polycondensation towards completion. ns described herein unless otherwise stated.

The invention further relates to a polymer blend. The blend comprises: (a) from 5 to 95 weight % of at least one of the polyesters described above; and (b) from 5 to 95 weight % of at least one of the polymeric components.

Suitable examples of the polymeric components include, but are not limited to, nylon; polyesters other than the ones described otherwise herein; polyamides such as ZYTEL® from DuPont; polystyrene; polystyrene copolymers; styrene acrylonitrile copolymers; acrylonitrile butadiene styrene copolymers; poly(methylmethacrylate); acrylic copolymers; poly(ether-imides) such as ULTEM® (a poly(ether-imide) from General Electric); polyphenylene oxides such as poly(2,6-dimethylphenylene oxide) or poly(phenylene oxide)/polystyrene blends such as NORYL 1000® (a blend of poly(2,6-dimethylphenylene oxide) and polystyrene resins from General Electric); polyphenylene sulfides; polyphenylene sulfide/sulfones; poly(ester-carbonates); polycarbonates such as LEXAN® (a polycarbonate from General Electric); polysulfones; polysulfone ethers; and poly(ether-ketones) of aromatic dihydroxy compounds; or combinations of any of the foregoing polymers. The blends can be prepared by conventional processing techniques known in the art, such as melt blending or solution blending.

In one embodiment, the final polyester compositions of the invention can be blended with or contain recycled poly(ethylene terephthalate) (rPET).

In certain embodiment, the polyester compositions and the polymer blend compositions can also contain from 0.01 to 25% by weight of the overall composition common additives such as colorants, toner(s), dyes, mold release agents, flame retardants, plasticizers, nucleating agents, stabilizers, including but not limited to, UV stabilizers, thermal stabilizers other than the phosphorus compounds describe herein, and/or reaction products thereof, fillers, and impact modifiers. Examples of commercially available impact modifiers include, but are not limited to, ethylene/propylene terpolymers, functionalized polyolefins such as those containing methyl acrylate and/or glycidyl methacrylate, styrene-based block copolymeric impact modifiers, and various acrylic core/shell type impact modifiers. Residues of such additives are also contemplated as part of the polyester composition.

Reinforcing materials may be added to the compositions of this invention. The reinforcing materials may include, but are not limited to, carbon filaments, silicates, mica, clay, talc, titanium dioxide, Wollastonite, glass flakes, glass beads and fibers, and polymeric fibers and combinations thereof. In one embodiment, the reinforcing materials include glass, such as, fibrous glass filaments, combinations of glass and talc, glass and mica, and glass and polymeric fibers.

In one embodiment, the processes of making the polyesters of the invention comprise a continuous process or a semi-continuous process.

In certain embodiments, the b* values for the polyesters and/or polyester compositions of the invention can be from −10 to less than 20, −10 to less than 10, or from 1 to less than 20, or from 5 to less than 20, or from 8 to less than 20, or from −3 to 10, or from −5 to 5, or from −5 to 4, or from −5 to 3, or from 1 to 15, or from 1 to 14, or from 1 to 13, or from 1 to 12, or from 1 to 11, or from 1 to 10, or from 1 to 9, or from 1 to 8, from 1 to 7, or from 1 to 6, or from 1 to 5, or less than 20, or less than 15, or less than 10, or less than 8, or less than 7, or less than 6, or less than 5, or less than 4, or less than 3. In one embodiment, the b* values for the polyesters and/or polyester compositions of the invention can be from less than 10, or less than 8, or less than 7, or less than 6, or less than 5, or less than 4, or less than 3, as determined by the L*a*b* color system of the CIE (International Commission on Illumination).

In certain embodiments, the L* values for the polyesters and/or polyester compositions of the invention can be from 50 to 99, or from 50 to 90, or from 60 to 99, or from 60 to 90, or from 60 to 85, or from 60 to 80, or from 65 to 99, or from 65 to 90, or from 65 to 85, or from 65 to 80, or from 65 to 75, or from 70 to 90, or from 70 to 99, or from 70 to 90, or from 70 to 85, or from 70 to 80, or from 75 to 95, or from 75 to 90, or from 75 to 85, or from 80 to 90, as determined by the L*a*b* color system of the CIE (International Commission on Illumination).

In one embodiment, a product is provided which can be made with any of the polyester compositions of the invention or by any of the processes of the invention.

In one embodiment, an article of manufacture is provided which can be made with any of the polyester compositions of the invention or by any of the processes of the invention.

In one embodiment, a shaped article is provided which is made with any of the polyester compositions of the invention or by any of the processes of the invention.

In one embodiment, the polyesters and/or the polyester compositions of the invention can be useful for thermoplastic polyester compositions, articles of manufacture, shaped articles, thermoplastic shaped articles, molded articles, extruded articles, injection molded articles, blow molded articles, film and/or sheet (for example, calendered, cast, or extruded), containers, and/or bottles (for example, beverage bottles, water bottles).

In one embodiment, the polyesters and/or the polyester compositions of the invention can be useful for films, sheets, bottle preforms, beverage bottle preforms, and blow molded bottles made therefrom.

In one embodiment, the polyester compositions of the invention are useful in shaped articles, including, but not limited to, extruded, and/or molded articles including, but not limited to, injection molded articles, extruded articles, cast extrusion articles, profile extrusion articles, melt spun articles, thermoformed articles, extrusion molded articles, injection blow molded articles, injection stretch blow molded articles, extrusion blow molded articles and extrusion stretch blow molded articles. These articles can include, but are not limited to, films, bottles, containers, drinkware, medical parts, sheet and/or fibers.

In one embodiment, the polyester compositions of the invention may be used in various types of film and/or sheet, including but not limited to extruded film(s) and/or sheet(s), compression molded film(s) and/or sheet(s), solution casted film(s) and/or sheet(s). Methods of making film and/or sheet include but are not limited to extrusion, compression molding, and solution casting.

In one embodiment, the invention is related to articles of manufacture, e.g., shaped articles, that comprise any of the polyesters or polyester compositions of the invention.

In one embodiment, any of the processes of making the polyesters useful in the invention and described herein or known by one of ordinary skill in the art may be used to make any of the polyesters and/or polyester compositions of the invention.

In one embodiment, any of the polyesters and/or polyester compositions described herein are also considered within the scope of this invention, regardless of which process is used to make them, and any products made therefrom.

In one embodiment, any of the processes of making the polyesters useful in the invention and described herein or known by one of ordinary skill in the art may be used to make any of the polyesters and/or polyester composition of the invention.

The following examples further illustrate how the polyesters of the invention can be made and evaluated and are intended to be purely exemplary of the invention and are not intended to limit the scope thereof. Unless indicated otherwise, parts are parts by weight, temperature is in degrees C. or is at room temperature, and pressure is at or near atmospheric.

### EXAMPLES

The following examples illustrate, in general, how copolyesters of this invention are prepared and the effect of certain catalyst and stabilizers, on various copolyester properties such as color and inherent viscosity (IV).

### Measurement Methods

Unless otherwise noted, IV or I.V. is meant to refer to inherent viscosity measured as described herein.

The inherent viscosity (IV) of the polyesters was determined in 60/40 (wt/wt) phenol/tetrachloroethane at a concentration of 0.5 g/100 ml at 25° C., and is reported in dL/g. The amount of Germanium (Ge) metal in the experimental sample is reported in parts per million (ppm) of metal and was measured by x-ray fluorescence (XRF) using a PAN analytical Axios Advanced wavelength dispersive x-ray fluorescence spectrometer.

### Examples 1-17

Experiments (Examples 1-17) were conducted to examine the effect of increasing the surface area to volume ratio by reducing the amount of BHET charged to a given reactor. The charges of BHET in these experiments ranged from 0.1 moles, high surface area to volume ratio, to 0.5 moles, low surface area to volume ratio. The catalyst used was germanium isopropoxide in n-Butanol (~2.29 wt./vol % Ge) with a target concentration of 200 ppm germanium (Ge) based on the final polyester mass. Table 1 shows the charges of BHET and Ge for the various mole scales run and the expected amount of polyethylene terephthalate (PET) formed, and final Ge concentration expected assuming no loss.

TABLE 1
Material charges and yield in the production
of PET from BHET at various scales.

| | | | | Ge concentration |
|---|---|---|---|---|
| | | Ge Solution | | expected in PET based |
| Scale (mol) | BHET (g) | (ml) | PET (g) | on Ge charged (ppm) |
| 0.10 | 25.42 | 0.17 | 19.22 | 200 |
| 0.15 | 38.13 | 0.25 | 28.83 | 200 |
| 0.20 | 50.84 | 0.34 | 38.44 | 200 |
| 0.25 | 63.55 | 0.43 | 48.05 | 200 |
| 0.30 | 76.26 | 0.51 | 57.66 | 200 |
| 0.35 | 88.97 | 0.60 | 67.27 | 200 |
| 0.40 | 101.68 | 0.68 | 76.88 | 200 |
| 0.45 | 114.39 | 0.77 | 86.49 | 200 |
| 0.50 | 127.10 | 0.85 | 96.10 | 200 |

BHET was placed into a 500 mL round bottom flask. Catalyst was then added with a pipette. The round bottom was fitted with a stainless-steel stirrer and a distillation head and then clamped on the polymerization rig. A distillation side arm and Erlenmeyer flask were then attached to the distillation head. From the Erlenmeyer flask a vacuum system was attached. The procedure was controlled by the Camile® TG Data Acquisition and Process Control System following the reaction profile listed in Table 2. Before the process was started, a Belmont metal bath was preheated to 250° C. During the reaction, a N₂ flow of 0.2 scfh was kept over the flask contents until vacuum was applied. Once the synthesis process concluded, the polymer was pulled, removed from the stir rod, and then placed into a black bag. The material was then ground to 6 mm and tested by the various methods mentioned below.

TABLE 2
Camile reaction profile used for PET synthesis from BHET.

| | Time | Temp | Vac | Stir |
|---|---|---|---|---|
| Stage | (min) | (° C.) | (Torr) | (RPM) |
| 1 | 0.5 | 250 | 730 | 0 |
| 2 | 5 | 250 | 730 | 200 |
| 3 | 30 | 275 | 730 | 200 |
| 4 | 20 | 275 | X | 200 |
| 5 | 120 | 275 | X | 200 |
| 6 | 1 | 275 | 730 | 0 |

FIG. 2 shows the impact of changing the amount of BHET charged to the reaction flask on the amount of Ge left in the final polymer as well as the inherent viscosity (IV) of the PET based on a final vacuum level (X, in stages 4 and 5) of 0.3 torr. As BHET charge decreases in a given sized reactor, one is increasing the surface area to volume ratio. This in theory allows the Ge and ethylene glycol (EG) to be more easily removed. In the limit of a “perfect” thin film, in the limit of no charge, essentially all the Ge could be removed despite an initial charge of Ge was 200 ppm. So even at a BHET charges of 0.1 and 0.15 mol, one is approaching 99% of the Ge removed. One risk of removing the catalyst is a potential loss of catalytic activity resulting in a lower IV. However, surprisingly there was no effect on catalytic activity with respect to achieving IV for the same reaction profile. This clearly shows that in a finishing reactor design with a high surface area to volume ratio (thin film), a high inherent viscosity catalyst free polyethylene terephthalate (PET) or extremely low residual catalyst level (<5 ppm Ge) PET can be made. Low BHET charge to a given reactor can also create the high surface area to volume ratio. These polymers had good color.

Additional experiments were conducted at final vacuum levels of 1.0 torr and 3.0 torr instead of 0.3 (Stages 4 and 5 in the reaction profile in Table 2). As shown in FIG. 3, even at 1.0 and 3.0 torr, it was easy to remove the Ge at high surface area to volume ratio (i.e. reduced BHET charge). It should be noted, not surprisingly, that at the same reaction time of 120 minutes and vacuum levels of 1 torr and 3 torr did result in lower IVs at all levels of BHET charges likely because of less EG removal.

TABLE 3

| | BHET Charge | Final Vacuum | Ge in Final | IV |
|---|---|---|---|---|
| Example | (mol) | Level (Torr) | Polymer (ppm) | (dL/g) |
| 1 | 0.50 | 0.3 | 30 | 0.78 |
| 2 | 0.40 | 0.3 | 26 | 0.77 |
| 3 | 0.30 | 0.3 | 15 | 0.77 |
| 4 | 0.20 | 0.3 | 8 | 0.69 |
| 5 | 0.10 | 0.3 | 4 | 0.82 |
| 6 | 0.40 | 0.3 | 20 | 0.80 |
| 7 | 0.15 | 0.3 | 3 | 0.76 |
| 8 | 0.25 | 0.3 | 13 | 0.69 |
| 9 | 0.35 | 0.3 | 20 | 0.68 |
| 10 | 0.45 | 0.3 | 23 | 0.76 |
| 11 | 0.1 | 3 | 0 | 0.69 |
| 12 | 0.2 | 3 | 7 | 0.55 |
| 13 | 0.3 | 3 | 19 | 0.49 |
| 14 | 0.4 | 3 | 51 | 0.62 |
| 15 | 0.1 | 1 | 4 | 0.77 |
| 16 | 0.2 | 1 | 9 | 0.68 |
| 17 | 0.3 | 1 | 12 | 0.70 |

The percentage of germanium loss by weight was calculated for Examples 1-17 in Table 4. For example, in Example 1, the calculation was made as follows: (200-30)/(200)×100 equals 85% by weight germanium loss. In Example 1, germanium was fed to the reaction in an amount of 200 ppm, there was 30 ppm germanium found in the final polymer and 170 ppm Ge was removed by vacuum.

TABLE 4

| | | Final | | | |
|---|---|---|---|---|---|
| | BHET | Vacuum | | % Ge loss | |
| | Charge | Level | Ge in Final | or recovery | IV |
| Example | (mol) | (Torr) | Polymer (ppm) | by weight | (dL/g) |
| 1 | 0.50 | 0.3 | 30 | 85 | 0.78 |
| 2 | 0.40 | 0.3 | 26 | 87 | 0.77 |
| 3 | 0.30 | 0.3 | 15 | 92.5 | 0.77 |
| 4 | 0.20 | 0.3 | 8 | 96 | 0.69 |
| 5 | 0.10 | 0.3 | 4 | 98 | 0.82 |
| 6 | 0.40 | 0.3 | 20 | 90 | 0.80 |
| 7 | 0.15 | 0.3 | 3 | 98.5 | 0.76 |
| 8 | 0.25 | 0.3 | 13 | 93.5 | 0.69 |
| 9 | 0.35 | 0.3 | 20 | 90 | 0.68 |
| 10 | 0.45 | 0.3 | 23 | 88.5 | 0.76 |
| 11 | 0.1 | 3 | 0 | 100 | 0.69 |
| 12 | 0.2 | 3 | 7 | 96.5 | 0.55 |
| 13 | 0.3 | 3 | 19 | 90.5 | 0.49 |
| 14 | 0.4 | 3 | 51 | 74.5 | 0.62 |
| 15 | 0.1 | 1 | 4 | 98 | 0.77 |
| 16 | 0.2 | 1 | 9 | 95.5 | 0.68 |
| 17 | 0.3 | 1 | 12 | 94 | 0.70 |

It is unpredictable that use of germanium as a catalyst, in the process of the invention, results in good inherent viscosities for these polyesters where the final polyester has little to no remaining catalyst residues.

This disclosure has been described in detail with particular reference to preferred embodiments thereof, but it will be understood that variations and modifications can be effected within the spirit and scope of the disclosure.

1. A polyester composition comprising:
(1) at least one polyester which comprises:
(a) a dicarboxylic acid component comprising:
(i) about 70 to about 100 mole % residues of terephthalic acid or esters thereof;
(ii) about 0 to about 30 mole % of aromatic or aliphatic dicarboxylic acid residues, or combinations thereof, having up to 20 carbon atoms;
(b) a glycol component comprising:
(i) about 50 to about 100 mole % of ethylene glycol residues;
(ii) about 0 to about 50 mole % residues of modifying glycols comprising linear or alicyclic residues containing 2 to 20 carbon atoms;
wherein the total mole % of the dicarboxylic acid component is 100 mole %, wherein the total mole % of the glycol component is 100 mole %; and
(2) residues of a metal catalyst system consisting essentially of germanium atoms in the amount of 75 ppm or less, relative to the mass of final polyester being prepared; and
wherein the inherent viscosity of the final polyester is 0.45 to 1.2 dL/g as determined in 60/40 (wt/wt) phenol/tetrachloroethane at a concentration of 0.5 g/100 ml at 25° C.

2. The polyester composition of claim 1 wherein said modifying glycols comprise at least one of diethylene glycol, 1,2-propanediol, 1,3-propanediol, 2-methyl-1,3-propanediol, 1,4-cyclohexanedimethanol, 2,2,4,4-tetramethyl-1,3-cyclobutanediol, 1,4-butanediol, 1,5-pentanediol, 1,6-hexanediol, p-xylene glycol, neopentyl glycol, isosorbide, polytetramethylene glycol, or combinations thereof.

3. The polyester composition of claim 1 wherein said modifying glycol comprises residues of 2,2,4,4-tetramethyl-1,3-cyclobutanediol.

4. The polyester composition of claim 1 wherein said modifying glycol comprises residues of 1,4-cyclohexanedimethanol.

5. The polyester composition of claim 1 wherein said modifying glycol is in the amount of from about 10 to about 45 mole %, or from about 15 to about 45 mole %, or from about 10 to about 40 mole %, or from about 20 to about 40 mole %, or from about 10 to about 30 mole %, or from about 20 to about 35 mole %, or from about 20 to about 30 mole %, or from about 25 to about 40 mole %, or from about 30 to about 40 mole %.

6. The polyester composition of claim 1 wherein said polyester comprises residues of ethylene glycol in the amount of from about 55 to about 90 mole %, or from about 55 to about 85 mole %, or from about 60 to about 90 mole %, or from about 60 to about 80 mole %, or from about 65 to about 80 mole %, or from about 70 to about 90 mole %, or from about 70 to about 80 mole % or from about 60 to about 75 mole %, or from about 60 to about 70 mole %.

7. The polyester composition of claim 1 wherein said polyester comprises residues of a diacid component comprising aromatic or aliphatic dicarboxylic acid ester residues, or combinations thereof.

8. The polyester composition of claim 1 wherein said polyester comprises from about 80 to about 100 mole %, or to about 90 to about 100 mole %, or about 95 to about 100 mole %, or about 99 to about 100 mole %, of residues of terephthalic acid or esters thereof.

9. The polyester composition of claim 1 wherein the inherent viscosity is from 0.45 to 1.2 dL/g, or from 0.45 to 1.0 dL/g, or from 0.45 to 0.90 dL/g, or from 0.45 to 0.85 dL/g, or from 0.45 to 0.80 dL/g, or from 0.45 to 0.75 dL/g, or from 0.45 to 0.70 dL/g, or from 0.50 to 1.2 dL/g, or from 0.50 to 1.0 dL/g, or from 0.50 to 0.90 dL/g, or from 0.50 to 0.85 dL/g, or from 0.50 to 0.80 dL/g, or from 0.50 to 0.75 dL/g, or from 0.50 to 0.70 dL/g, or from 0.55 to 1.2 dL/g, or from 0.55 to 1.0 dL/g, or from 0.55 to 0.90 dL/g, or from 0.55 to 0.85 dL/g, or from 0.55 to 0.80 dL/g, or from 0.55 to 0.75 dL/g, or from 0.55 to 0.70 dL/g, or 0.60 to 1.2 dL/g, or from 0.60 to 1.0 dL/g, or from 0.60 to 0.90 dL/g, or from 0.60 to 0.85 dL/g, or from 0.60 to 0.80 dL/g, or from 0.60 to 0.75 dL/g, or from 0.60 to 0.70 dL/g, or from 0.65 to 1.2 dL/g, or from 0.65 to 1.0 dL/g, or from 0.65 to 0.90 dL/g, or from 0.65 to 0.85 dL/g, or from 0.65 to 0.80 dL/g, or from 0.65 to 0.75 dL/g, or from 0.68 to 1.2 dL/g, or from 0.60 to 1.0 dL/g, or from 0.68 to 0.90 dL/g, or from 0.68 to 0.85 dL/g, or from 0.68 to 0.80 dL/g, as determined in 60/40 (wt/wt) phenol/tetrachloroethane at a concentration of 0.5 g/100 ml at 25° C.

10. The polyester composition of claim 1 wherein the inherent viscosity of the polyester is from 0.45 to 0.90 dL/g, or from 0.45 to 0.85 dL/g, or from 0.45 to 0.80 dL/g, or from 0.45 to 0.75 dL/g, or from 0.45 to 0.70 dL/g, or from 0.50 to 0.90 dL/g, or from 0.50 to 0.85 dL/g, or from 0.50 to 0.80 dL/g, or from 0.55 to 0.90 dL/g, or from 0.55 to 0.85 dL/g, or from 0.55 to 0.80 dL/g, or from 0.60 to 0.90 dL/g, or from 0.60 to 0.85 dL/g, or from 0.60 to 0.80 dL/g, or from 0.60 to 0.75 dL/g, or from 0.60 to 0.70 dL/g, or from 0.65 to 0.90 dL/g, or from 0.65 to 0.85 dL/g, or from 0.65 to 0.80 dL/g, or from 0.65 to 0.75 dL/g, or from 0.68 to 0.90 dL/g, or from 0.68 to 0.85 dL/g, or from 0.68 to 0.80 dL/g, as determined in 60/40 (wt/wt) phenol/tetrachloroethane at a concentration of 0.5 g/100 ml at 25° C.

11. The polyester composition of claim 1 wherein the inherent viscosity of the polyester is from 0.45 to 0.90 dL/g, or from 0.45 to 0.85 dL/g, or from 0.45 to 0.80 dL/g, or from 0.50 to 0.90 dL/g, or from 0.50 to 0.85 dL/g, or from 0.50 to 0.80 dL/g, or from 0.55 to 0.90 dL/g, or from 0.55 to 0.85 dL/g, or from 0.55 to 0.80 dL/g, or from 0.60 to 0.90 dL/g, or from 0.60 to 0.85 dL/g, or from 0.60 to 0.80 dL/g, or from 0.65 to 0.90 dL/g, or from 0.65 to 0.85 dL/g, or from 0.65 to 0.80 dL/g, and the amount of germanium atoms present in the final polyester composition is 70 ppm or less, or 65 ppm or less, or 55 ppm or less, or 45 ppm or less, or 40 ppm or less, or 30 ppm or less, or 25 ppm or less, or 20 ppm or less.

12. The polyester composition of claim 1 wherein the inherent viscosity of the polyester is from 0.50 to 0.90 dL/g, or from 0.50 to 0.85 dL/g, or from 0.50 to 0.80 dL/g, or from 0.55 to 0.90 dL/g, or from 0.55 to 0.85 dL/g, or from 0.55 to 0.80 dL/g, or from 0.60 to 0.90 dL/g, or from 0.60 to 0.85 dL/g, or from 0.60 to 0.80 dL/g, or from 0.65 to 0.90 dL/g, or from 0.65 to 0.85 dL/g, or from 0.65 to 0.80 dL/g, and the amount of germanium atoms present in the final polyester composition is 18 ppm or less, or 15 ppm or less, or 10 ppm or less, or 5 ppm or less.

13. The polyester composition of claim 1 or claim 10 wherein less than 70 ppm, or less than 65 ppm, or less than 60 ppm, or less than 55 ppm, or less than 50 ppm, or less than 45 ppm, or less than 40 ppm, or less than 35 ppm, or less than 30 ppm, or less than 25 ppm, or less than 20 ppm, or less than 18 ppm, or less than 15 ppm, or 10 ppm or less, or 5 ppm or less, or less than 5 ppm, of germanium atoms are present in the final polyester composition.

14. The polyester composition of claim 1 wherein the amount of germanium atoms present in the final polyester composition is 18 ppm or less, or 15 ppm or less, or 10 ppm or less, or 5 ppm or less, or less than 5 ppm.

15. The polyester composition of claim 1 having a b* value of from −10 to less than 20, −10 to less than 10, or from 1 to less than 20, or from 5 to less than 20, or from 8 to less than 20, or from −3 to 10, or from −5 to 5, or from −5 to 4, or from −5 to 3, or from 1 to 15, or from 1 to 14, or from 1 to 13, or from 1 to 12, or from 1 to 11, or from 1 to 10, or from 1 to 9, or from 1 to 8, from 1 to 7, or from 1 to 6, or from 1 to 5, or less than 20, or less than 15, or less than 10, or less than 8, or less than 7, or less than 6, or less than 5, or less than 4, or less than 3, as determined by the L*a*b* color system of the CIE (International Commission on Illumination).

16. The polyester composition of claim 1 having a L* value of from 50 to 99, or from 50 to 90, or from 60 to 99, or from 60 to 90, or from 60 to 85, or from 60 to 80, or from 65 to 99, or from 65 to 90, or from 65 to 85, or from 65 to 80, or from 65 to 75, or from 70 to 90, or from 70 to 99, or from 70 to 90, or from 70 to 85, or from 70 to 80, or from 75 to 95, or from 75 to 90, or from 75 to 85, or from 80 to 90, as determined by the L*a*b* color system of the CIE (International Commission on Illumination).

17. The polyester composition of claim 1 wherein said polyester comprises residues of at least one branching agent or comprises no branching agent or comprises 1 mole % or less branching agent.

18. The polyester composition of claim 1 wherein at least one germanium compound is selected from germanium alkoxides, germanium carboxylates, organogermanium compounds, or esters of germanic acid.

19. The polyester composition of claim 1 wherein at least one germanium compound is selected from germanium alkoxides and carboxylates.

20. The polyester composition of claim 1 wherein said germanium compound is selected from germanium ethoxide, germanium isopropoxide, and germanium acetate, or germanium dioxide.

21. The polyester composition of claim 1 wherein said polyester composition comprises a blend with at least one polymer chosen from at least one of the following: polyesters other than those in claim 1 poly(etherimides), polyphenylene oxides, poly(phenylene oxide)/polystyrene blends, polystyrene resins, polyphenylene sulfides, polyphenylene sulfide/sulfones, poly(ester-carbonates), polycarbonates, polysulfones; polysulfone ethers, and poly(ether-ketones).

22. A process for making the polyester of claim 1.

23. The process of claim 22 wherein the total loss of catalyst or removal of catalyst is greater than 70%, or greater than 75%, or greater than 80%, or greater than 85%, or greater than 86%, or greater than 87%, or greater than 88%, or greater than 89%, or greater than 90%, or greater than 95%, or greater than 96%, or greater than 97%, or greater than 98%, or greater than 99%.

24. The process of claim 23 wherein said loss of catalyst or removal of catalyst occurs in the finisher or finishing reactor.

25. The process of claim 22 wherein the amount of germanium catalyst introduced to the polycondensation zone can be in the amount of at least 20 ppm, or at least 50 ppm, or at least 100 ppm, or from 20 to 500 ppm, or from 20 to 450 ppm, or from 20 to 400 ppm, or from 20 to 350 ppm, or from 20 to 300 ppm, or from 20 to 250 ppm, or from 50 to 500 ppm, or from 50 to 450 ppm, or from 50 to 400 ppm, or from 50 to 350 ppm, or from 50 to 300 ppm, or from 50 to 250 ppm, or from 100 to 500 ppm, or from 100 to 450 ppm, or from 20 to 400 ppm, or from 100 to 350 ppm, or from 100 to 300 ppm, or from 100 to 250 ppm, or from 150 to 500 ppm, or from 150 to 450 ppm, or from 150 to 400 ppm, or from 150 to 350 ppm, or from 150 to 300 ppm, or from 150 to 250 ppm, or from 175 to 500 ppm, or from 175 to 450 ppm, or from 175 to 400 ppm, or from 175 to 350 ppm, or from 175 to 300 ppm, or from 175 to 250 ppm, or from 200 to 500 ppm, or from 200 to 450 ppm, or from 200 to 400 ppm, or from 200 to 350 ppm, or from 200 to 300 ppm, or from 200 to 250 ppm.

26. The process of claim 22 comprising a dihydroxy terephthalate-containing compound which is bis-2-hydroxyethyl terephthalate (BHET).

27. The process of claim 22 wherein at least one dihydroxy terephthalate-containing compound is fed to a finishing reactor operating in the range of 240° C.-300° C. with vacuum levels between 0.1-5 torr and a total process time of from 15 minutes to 8 hours, wherein germanium is a catalyst and wherein the final product has an inherent viscosity of at least 0.45 dL/g and contains less than 75 ppm germanium atoms.

28. The process of claim 22 wherein at least one dihydroxy terephthalate-containing compound is fed to a finishing reactor operating in the range of 240° C.-300° C. with vacuum levels between 0.1-1 torr and a total process time of from 15 minutes to 8 hours, wherein germanium is a catalyst and wherein the final product has an inherent viscosity of at least 0.65 dL/g and contains less than 75 ppm, or less than 50 ppm, or less 25 ppm, or less than 15 ppm, or less than 10 ppm, germanium atoms.
